(19) United States
(12) Patent Application Publication
(10) Pub. No.: US 2015/0329780 A1
(43) Pub. Date: Nov. 19, 2015

(54) LIQUID CRYSTAL COMPOSITION AND LIQUID CRYSTAL DISPLAY DEVICE

(71) Applicants: JNC CORPORATION, TOKYO (JP); JNC PETROCHEMICAL CORPORATION, TOKYO (JP)

(72) Inventors: MASAYUKI SAITO, CHIBA (JP); YOSHIMASA FURUSATO, CHIBA (JP)

(21) Appl. No.: 14/667,695

(22) Filed: Mar. 25, 2015

(30) Foreign Application Priority Data
May 14, 2014 (JP) 2014-100419
Oct. 29, 2014 (JP) 2014-220113

(51) Int. Cl. C09K 19/54; C09K 19/34; C09K 19/30

(52) U.S. Cl. CPC C09K 19/542; C09K 19/3068; C09K 19/3402; C09K 19/3066; C09K 19/3098; C09K 2019/3071; C09K 2019/3425; C09K 2019/3078; C09K 2019/3422; C09K 2019/548

(57) ABSTRACT

To provide a liquid crystal composition satisfying at least one or a suitable balance regarding at least two of characteristics such as high maximum temperature and low minimum temperature of a nematic phase, small viscosity, suitable optical anisotropy, large negative dielectric anisotropy, large specific resistance and high stability to ultraviolet light and heat, and to provide an AM device having characteristics such as short response time, a large voltage holding ratio, a large contrast ratio and long service life. The composition contains a specific compound having large negative dielectric anisotropy as a first component and a specific compound having small viscosity as a second component, and may contain a specific compound having high maximum temperature or small viscosity as a third component, a specific compound having negative dielectric anisotropy as a fourth component, and a specific compound having a polymerizable compound as an additive component.

### CROSS-REFERENCE TO RELATED APPLICATION

This application claims the priority benefits of Japanese application serial no. 2014-100419, filed on May 14, 2014, and Japanese application serial no. 2014-220113, filed on Oct. 29, 2014. The entirety of each of the above-mentioned patent applications is hereby incorporated by reference herein and made a part of this specification.

### TECHNICAL FIELD

The invention relates to a liquid crystal composition, a liquid crystal display device including the composition and so forth. In particular, the invention relates to a liquid crystal composition having a negative dielectric anisotropy, and a liquid crystal display device that includes the liquid crystal composition and has a mode such as an IPS mode, a VA mode, an FFS mode and an FPA mode. The invention also relates to a liquid crystal display device having a polymer sustained alignment mode.

### BACKGROUND ART

In a liquid crystal display device, a classification based on an operating mode for liquid crystals includes a phase change (PC) mode, a twisted nematic (TN) mode, a super twisted nematic (STN) mode, an electrically controlled birefringence (ECB) mode, an optically compensated bend (OCB) mode, an in-plane switching (IPS) mode, a vertical alignment (VA) mode, a fringe field switching (FFS) and a field induced photo-reactive alignment (FPA) mode. A classification based on a driving mode in the device includes a passive matrix (PM) and an active matrix (AM). The PM is classified into static and multiplex and so forth. The AM is classified into a thin film transistor (TFT), a metal insulator metal (MIM) and so forth. The TFT is further classified into amorphous silicon and polycrystal silicon. The latter is classified into a high temperature type and a low temperature type based on a production process. A classification based on a light source includes a reflection type utilizing natural light, a transmissive type utilizing backlight and a transreflective type utilizing both the natural light and the backlight.

The liquid crystal display device includes a liquid crystal composition having a nematic phase. The composition has suitable characteristics. An AM device having good characteristics can be obtained by improving characteristics of the composition. Table 1 below summarizes a relationship of the characteristics between two aspects. The characteristics of the composition will be further described based on a commercially available AM device. A temperature range of the nematic phase relates to a temperature range in which the device can be used. A preferred maximum temperature of the nematic phase is approximately 70° C. or higher, and a preferred minimum temperature of the nematic phase is approximately −10° C. or lower. Viscosity of the liquid crystal composition relates to a response time in the device. A short response time is preferred for displaying moving images on the device. A shorter response time even by one millisecond is desirable. Accordingly, a small viscosity of the composition is preferred. A small viscosity at a low temperature is further preferred.

TABLE 1
Characteristics of Composition and AM Device

| No. | Characteristics of Composition | Characteristics of AM Device |
|---|---|---|
| 1 | Wide temperature range of | Wide usable temperature range |
| | a nematic phase | |
| 2 | Small viscosity | Short response time |
| 3 | Suitable optical anisotropy | Large contrast ratio |
| 4 | Large positive or negative | Low threshold voltage and |
| | dielectric anisotropy | small electric power consumption |
| | | Large contrast ratio |
| 5 | Large specific resistance | Large voltage holding ratio and |
| | | large contrast ratio |
| 6 | High stability to ultraviolet | Long service life |
| | light and heat | |

An optical anisotropy of the composition relates to a contrast ratio in the device. According to a mode of the device, a large optical anisotropy or a small optical anisotropy, more specifically, a suitable optical anisotropy is required. A product (Δn×d) of the optical anisotropy (Δn) of the composition and a cell gap (d) in the device is designed so as to maximize the contrast ratio. A suitable value of the product depends on a type of the operating mode. The suitable value is in the range of approximately 0.30 micrometer to approximately 0.40 micrometer in a device having the VA mode, and in the range of approximately 0.20 micrometer to approximately 0.30 micrometer in a device having the IPS mode or the FFS mode. In the above cases, a composition having the large optical anisotropy is preferred for a device having a small cell gap. The large dielectric anisotropy in the composition contributes to a low threshold voltage, a small electric power consumption and a large contrast ratio in the device. Accordingly, the large dielectric anisotropy is preferred. A large specific resistance in the composition contributes to a large voltage holding ratio and the large contrast ratio in the device. Accordingly, a composition having a large specific resistance at room temperature and also at a high temperature in an initial stage is preferred. A composition having a large specific resistance at room temperature and also at a high temperature after the device has been used for a long period of time is preferred. Stability of the composition to ultraviolet light and heat relates to a service life of the liquid crystal display device. In the case where the stability is high, the device has a long service life. Such characteristics are preferred for an AM device used in a liquid crystal projector, a liquid crystal television and so forth.

In a liquid crystal display device having a polymer sustained alignment (PSA) mode, a liquid crystal composition containing a polymer is used. First, a composition to which a small amount of polymerizable compound is added is injected into the device. Then, the composition is irradiated with ultraviolet light while voltage is applied between substrates in the device. The polymerizable compound is polymerized to form a network structure of the polymer in the liquid crystal composition. In the composition, alignment of liquid crystal molecules can be controlled by the polymer, and therefore a response time in the device is shortened and also image persistence is improved. Such an effect of the polymer can be expected for a device having the mode such as the TN mode, the ECB mode, the OCB mode, the IPS mode, the VA mode, the FFS mode and the FPA mode.

A composition having a positive dielectric anisotropy is used for an AM device having the TN mode. In an AM device having the VA mode, a composition having a negative dielectric anisotropy is used. A composition having a positive or negative dielectric anisotropy is used for an AM device having the IPS mode or the FFS mode. A composition having a positive or negative dielectric anisotropy is used for an AM device having the polymer sustained alignment (PSA) mode. Examples of the liquid crystal compositions having the negative dielectric anisotropy are disclosed in Patent literature No. 1.

Patent literature No. 1: JP 2005-095311 A.

### SUMMARY OF INVENTION

The invention concerns a liquid crystal composition that has a negative dielectric anisotropy and contains at least one compound selected from the group consisting of compounds represented by formula (1) as a first component and at least one compound selected from the group consisting of compounds represented by formula (2) as a second component, and concerns a liquid crystal display device including the composition:

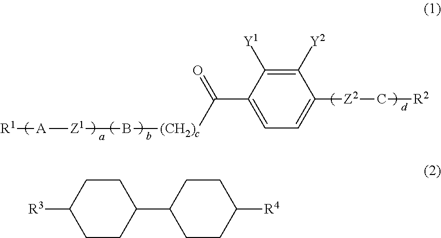

wherein, in formula (1) and formula (2), R¹ and R² are independently hydrogen, fluorine, chlorine, alkyl having 1 to 12 carbons, alkenyl having 2 to 12 carbons, alkenyloxy having 2 to 12 carbons, alkyl having 1 to 12 carbons in which at least one of hydrogen is replaced by fluorine or chlorine, or alkenyl having 2 to 12 carbons in which at least one of hydrogen is replaced by fluorine or chlorine; R³ and R⁴ are independently alkyl having 1 to 12 carbons, alkenyl having 2 to 12 carbons, alkyl having 1 to 12 carbons in which at least one of hydrogen is replaced by fluorine or chlorine, or alkenyl having 2 to 12 carbons in which at least one of hydrogen is replaced by fluorine or chlorine; A, B, and C are independently 1,4-cyclohexylene, 1,4-cyclohexenylene, 1,4-phenylene, or 1,4-phenylene in which at least one of hydrogen is replaced by fluorine or chlorine, or tetrahydropyran-2,5-diyl, naphthalene-2,6-diyl, naphthalene-2,6-diyl in which at least one of hydrogen is replaced by fluorine or chlorine, chroman-2,6-diyl, or chroman-2.6-diyl in which at least one of hydrogen is replaced by fluorine or chlorine; Z¹ and Z² are independently a single bond, ethylene, carbonyloxy or methyleneoxy; Y¹ is CF₂H or —CF₃; Y² is hydrogen, fluorine, chlorine, —CFH₂, —CF₂H or —CF₃; a, b and d are independently 0, 1, 2 or 3; a sum of a, b and d is 3 or less; and c is 0, 1, 2, 3, 4, 5, 6, 7, 8, 9 or 10.

The invention also concerns use of the liquid crystal composition in a liquid crystal display device.

### DESCRIPTION OF EMBODIMENTS

### Technical Problem

One of aims of the invention is to provide a liquid crystal composition satisfying at least one of characteristics such as a high maximum temperature of a nematic phase, a low minimum temperature of the nematic phase, a small viscosity, a suitable optical anisotropy, a large negative dielectric anisotropy, a large specific resistance, a high stability to ultraviolet light and a high stability to heat. Another aim is to provide a liquid crystal composition having a suitable balance regarding at least two of the characteristics. Another aim is to provide a liquid crystal display device including such a composition. Another aim is to provide an AM device having characteristics such as a short response time, a large voltage holding ratio, a low threshold voltage, a large contrast ratio and a long service life.

### Solution to Problem

The invention concerns a liquid crystal composition that has a negative dielectric anisotropy and contains at least one compound selected from the group consisting of compounds represented by formula (1) as a first component and at least one compound selected from the group consisting of compounds represented by formula (2) as a second component, and concerns a liquid crystal display device including the composition:

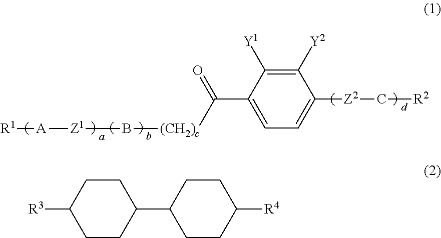

wherein, in formula (1) and formula (2), R¹ and R² are independently hydrogen, fluorine, chlorine, alkyl having 1 to 12 carbons, alkenyl having 2 to 12 carbons, alkenyloxy having 2 to 12 carbons, alkyl having 1 to 12 carbons in which at least one of hydrogen is replaced by fluorine or chlorine, or alkenyl having 2 to 12 carbons in which at least one of hydrogen is replaced by fluorine or chlorine; R³ and R⁴ are independently alkyl having 1 to 12 carbons, alkenyl having 2 to 12 carbons, alkyl having 1 to 12 carbons in which at least one of hydrogen is replaced by fluorine or chlorine, or alkenyl having 2 to 12 carbons in which at least one of hydrogen is replaced by fluorine or chlorine; A, B, and C are independently 1,4-cyclohexylene, 1,4-cyclohexenylene, 1,4-phenylene, or 1,4-phenylene in which at least one of hydrogen is replaced by fluorine or chlorine, or tetrahydropyran-2,5-diyl, naphthalene-2,6-diyl, naphthalene-2,6-diyl in which at least one of hydrogen is replaced by fluorine or chlorine, chroman-2,6-diyl, or chroman-2.6-diyl in which at least one of hydrogen is replaced by fluorine or chlorine; Z¹ and Z² are independently a single bond, ethylene, carbonyloxy or methyleneoxy; Y¹ is CF₂H or —CF₃; Y² is hydrogen, fluorine, chlorine, —CFH₂, —CF₂H or —CF₃; a, b and d are independently 0, 1, 2 or 3; a sum of a, b and d is 3 or less; and c is 0, 1, 2, 3, 4, 5, 6, 7, 8, 9 or 10.

The invention also concerns use of the liquid crystal composition in a liquid crystal display device.

### Advantageous Effects of Invention

An advantage of the invention is a liquid crystal composition satisfying at least one of characteristics such as a high maximum temperature of a nematic phase, a low minimum temperature of the nematic phase, a small viscosity, a large optical anisotropy, a large negative dielectric anisotropy, a large specific resistance, a high stability to ultraviolet light and a high stability to heat. Another advantage thereof is a liquid crystal composition having a suitable balance regarding at least two of the characteristics. Another advantage is a liquid crystal display device including such a composition. Another advantage is an AM device having characteristics such as a short response time, a large voltage holding ratio, a low threshold voltage, a large contrast ratio and a long service life.

Usage of terms herein is as described below. Terms “liquid crystal composition” and “liquid crystal display device” may be occasionally abbreviated as “composition” and “device,” respectively. The liquid crystal display device is a generic term for a liquid crystal display panel and a liquid crystal display module. The liquid crystal compound is a generic term for a compound having a liquid crystal phase such as a nematic phase and a smectic phase, and a compound having no liquid crystal phase but to be mixed with the composition for the purpose of adjusting characteristics such as a temperature range of the nematic phase, viscosity and dielectric anisotropy. The compound has a six-membered ring such as 1,4-cyclohexylene and 1,4-phenylene, and rod-like molecular structure. A polymerizable compound is added for the purpose of forming a polymer in the composition.

The liquid crystal composition is prepared by mixing a plurality of liquid crystal compounds. A ratio (content) of the liquid crystal compounds is expressed in terms of weight percent (% by weight) based on the weight of the liquid crystal composition. An additive such as an optically active compound, an antioxidant, an ultraviolet light absorber, a dye, an antifoaming agent, the polymerizable compound, a polymerization initiator and a polymerization inhibitor is added to the liquid crystal composition when necessary. A ratio (content) of the additive is expressed in terms of weight percent (% by weight) based on the weight of the liquid crystal composition in a manner similar to the ratio of the liquid crystal compound. Weight parts per million (ppm) may be occasionally used. A ratio of the polymerization initiator and the polymerization inhibitor is exceptionally expressed based on the weight of the polymerizable compound.

“Higher limit of the temperature range of the nematic phase” may be occasionally abbreviated as “maximum temperature.” “Lower limit of the temperature range of the nematic phase” may be occasionally abbreviated as “minimum temperature.” An expression “having a large specific resistance” means that the composition has a large specific resistance at room temperature and also at a temperature close to the maximum temperature of the nematic phase in an initial stage, and the composition has a large specific resistance at room temperature and also at a temperature close to the maximum temperature of the nematic phase even after the device has been used for a long period of time. An expression “having a large voltage holding” means that the device has a large voltage holding ratio at room temperature and also at a temperature close to the maximum temperature of the nematic phase in an initial stage, and the device has the large voltage holding ratio at room temperature and also at the temperature close to the maximum temperature of the nematic phase even after the device has been used for the long period of time. An expression “increase the dielectric anisotropy” means that a value of dielectric anisotropy positively increases in a liquid crystal composition having a positive dielectric anisotropy, and the value of dielectric anisotropy negatively increases in a liquid crystal composition having a negative dielectric anisotropy.

An expression “at least one of ‘A’ may be replaced by ‘B’” means that the number of ‘A’ is arbitrary. A position of ‘A’ is arbitrary when the number of ‘A’ is 1, and also positions thereof can be selected without restriction when the number of ‘A’ is two or more. A same rule also applies to an expression “at least one of ‘A’ is replaced by ‘B’.”

In formula (1) to formula (5), a symbol such as D, E, F, or the like surrounded by a hexagonal shape respectively corresponds to ring D, ring E, ring For the like. In formula (5), an oblique line crossing the hexagonal shape of ring K means that a bonding position on the ring can be arbitrarily selected for a P¹-Sp¹ group. A same rule also applies to a P²-Sp² group or the like. A subscript such as h represents the number of groups bonding to ring K or the like. When h is 2, two P¹-Sp¹ groups exist on ring K. Two groups represented by maybe identical or different. A same rule also applies to arbitrary two groups when h is larger than 2. A same rule also applies to any other group. A compound represented by formula (1) may be occasionally abbreviated as compound (1). A same abbreviation also applies to a compound represented by formula (2) or the like. Compound (1) means one compound or two or more compounds represented by formula (1). A symbol of terminal group R¹ is used for a plurality of compounds in chemical formulas of component compounds. In the compounds, two groups represented by two of arbitrary R¹ may be identical or different. In one case, for example, R¹ of compound (1-1) is ethyl and R¹ of compound (1-2) is ethyl. In another case, for example, R¹ of compound (1-1) is ethyl and R¹ of compound (1-2) is propyl. A same rule also applies to any other symbol of a terminal group. In formula (3), when n is 2, two of ring D exist. In the compound, two rings represented by two of ring D may be identical or different. A same rule applies to two of arbitrary ring D when n is larger than 2. A same rule also applies to a symbol Z³, ring F or the like.

Then, 2-fluoro-1,4-phenylene means two divalent groups described below. In the chemical formula, fluorine may be leftward (L) or rightward (R). A same rule also applies to a divalent group in an asymmetrical ring such as tetrahydropyran-2,5-diyl:

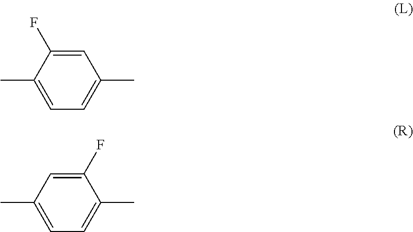

The invention includes the items described below.

Item 1. A liquid crystal composition that has a negative dielectric anisotropy and contains at least one compound selected from the group consisting of compounds represented by formula (1) as a first component and at least one compound selected from the group consisting of compounds represented by formula (2) as a second component:

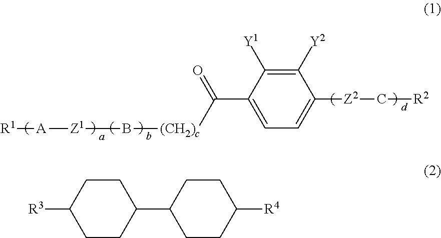

wherein, in formula (1) to formula (2), R¹ and R² are independently hydrogen, fluorine, chlorine, alkyl having 1 to 12 carbons, alkenyl having 2 to 12 carbons, alkenyloxy having 2 to 12 carbons, alkyl having 1 to 12 carbons in which at least one of hydrogen is replaced by fluorine or chlorine, or alkenyl having 2 to 12 carbons in which at least one of hydrogen is replaced by fluorine or chlorine; R³ and R⁴ are independently alkyl having 1 to 12 carbons, alkenyl having 2 to 12 carbons, alkyl having 1 to 12 carbons in which at least one of hydrogen is replaced by fluorine or chlorine, or alkenyl having 2 to 12 carbons in which at least one of hydrogen is replaced by fluorine or chlorine; A, B, and C are independently 1,4-cyclohexylene, 1,4-cyclohexenylene, 1,4-phenylene, or 1,4-phenylene in which at least one of hydrogen is replaced with fluorine or chlorine, or tetrahydropyran-2,5-diyl, naphthalene-2,6-diyl, naphthalene-2,6-diyl in which at least one of hydrogen is replaced by fluorine or chlorine, chroman-2,6-diyl, or chroman-2,6-diyl in which at least one of hydrogen is replaced by fluorine or chlorine; Z¹ and Z² are independently a single bond, ethylene, carbonyloxy or methyleneoxy; Y¹ is CF₂H or —CF₃; Y² is hydrogen, fluorine, chlorine, —CFH₂, —CF₂H or —CF₃; a, b and d are independently 0, 1, 2 or 3; a sum of a, b and d is 3 or less; and c is 0, 1, 2, 3, 4, 5, 6, 7, 8, 9 or 10.

Item 2. The liquid crystal composition according to item 1, containing at least one compound selected from the group consisting of compounds represented by formula (1-1) or formula (1-2) as the first component:

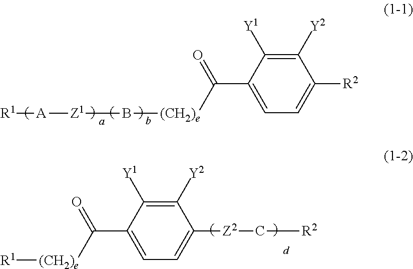

wherein, in formula (1-1) or formula (1-2), R¹ and R² are independently hydrogen, fluorine, chlorine, alkyl having 1 to 12 carbons, alkenyl having 2 to 12 carbons, alkenyloxy having 2 to 12 carbons, alkyl having 1 to 12 carbons in which at least one of hydrogen is replaced by fluorine or chlorine, or alkenyl having 2 to 12 carbons in which at least one of hydrogen is replaced by fluorine or chlorine; A, B and C are independently 1,4-cyclohexylene, 1,4-cyclohexenylene, or 1,4-phenylene, 1,4-phenylene in which at least one of hydrogen is replaced by fluorine or chlorine, or tetrahydropyran-2,5-diyl, naphthalene-2,6-diyl, naphthalene-2,6-diyl in which at least one of hydrogen is replaced by fluorine or chlorine, chroman-2,6-diyl, or chroman-2,6-diyl in which at least one of hydrogen is replaced by fluorine or chlorine; Z¹ and Z² are independently a single bond, ethylene, carbonyloxy or methyleneoxy; Y¹ is CF₂H or —CF₃; Y² is hydrogen, fluorine, chlorine, —CFH₂, —CF₂H or —CF₃; a, b and d are independently 0, 1, 2 or 3; a sum of a and b is 1, 2 or 3; and e is 0, 1, 2, 3, 4 or 5.

Item 3. The liquid crystal composition according to item 1 or 2, wherein a ratio of the first component is in the range of 3% by weight to 30% by weight and a ratio of the second component is in the range of 5% by weight to 60% by weight, based on the weight of the liquid crystal composition.

Item 4. The liquid crystal composition according to any one of items 1 to 3, containing at least one compound selected from the group consisting of compounds represented by formula (3) as a third component:

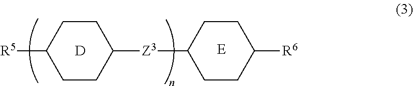

wherein, in formula (3), R⁵ and R⁶ are independently alkyl having 1 to 12 carbons, alkoxy having 1 to 12 carbons, alkenyl having 2 to 12 carbons, alkyl having 1 to 12 carbons in which at least one of hydrogen is replaced by fluorine or chlorine, or alkenyl having 2 to 12 carbons in which at least one of hydrogen is replaced by fluorine or chlorine; ring D and ring E are independently 1,4-cyclohexylene, 1,4-phenylene, 2-fluoro-1,4-phenylene or 2,5-difluoro-1,4-phenylene; Z³ is a single bond, ethylene or carbonyloxy; n is 1, 2 or 3; and ring E when n is 1 is 1,4-phenylene.

Item 5. The liquid crystal composition according to any one of items 1 to 4, containing at least one compound selected from the group consisting of compounds represented by formula (3-1) to formula (3-12) as the third component:

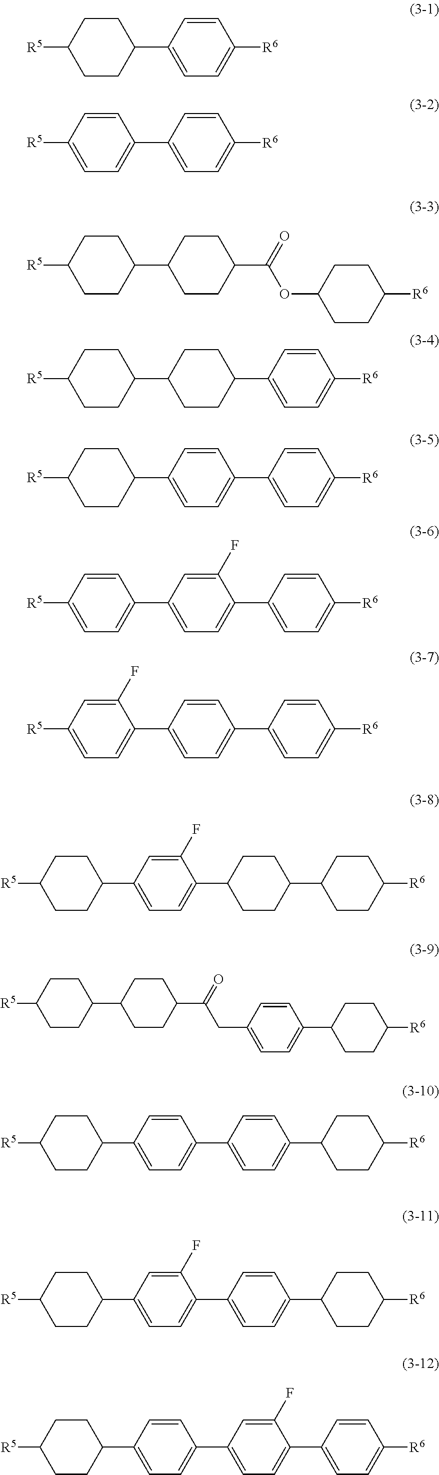

wherein, in formula (3-1) to formula (3-12), R⁵ and R⁶ are independently alkyl having 1 to 12 carbons, alkoxy having 1 to 12 carbons, alkenyl having 2 to 12 carbons, alkyl having 1 to 12 carbons in which at least one of hydrogen is replaced by fluorine or chlorine, or alkenyl having 2 to 12 carbons in which at least one of hydrogen is replaced by fluorine or chlorine.

Item 6. The liquid crystal composition according to item 4 or 5, wherein a ratio of the third component is in the range of 5% by weight to 50% by weight based on the weight of the liquid crystal composition.

Item 7. The liquid crystal composition according to any one of items 1 to 6, containing at least one compound selected from the group consisting of compounds represented by formula (4) as a fourth component:

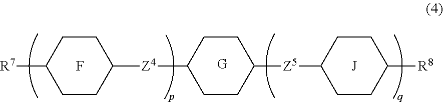

wherein, in formula (4), R⁷ and R⁸ are independently alkyl having 1 to 12 carbons, alkoxy having 1 to 12 carbons, alkenyl having 2 to 12 carbons, alkenyloxy having 2 to 12 carbons, or alkyl having 1 to 12 carbons in which at least one of hydrogen is replaced by fluorine or chlorine; ring F and ring J are independently 1,4-cyclohexylene, 1,4-cyclohexenylene, tetrahydropyran-2,5-diyl, 1,4-phenylene, or 1,4-phenylene in which at least one of hydrogen is replaced by fluorine or chlorine; ring G is 2,3-difluoro-1,4-phenylene, 2-chloro-3-fluoro-1,4-phenylene, 2,3-difluoro-5-methyl 1,4-phenylene, 3,4,5-trifluoronaphthalene-2,6-diyl or 7,8-difluorochroman-2,6-diyl; Z⁴ and Z⁵ are independently a single bond, ethylene, carbonyloxy or methyleneoxy; p is 1, 2 or 3; q is 0 or 1; and a sum of p and q is 3 or less.

Item 8. The liquid crystal composition according to any one of items 1 to 7, containing at least one compound selected from the group consisting of compounds represented by formula (4-1) to formula (4-19) as the fourth component:

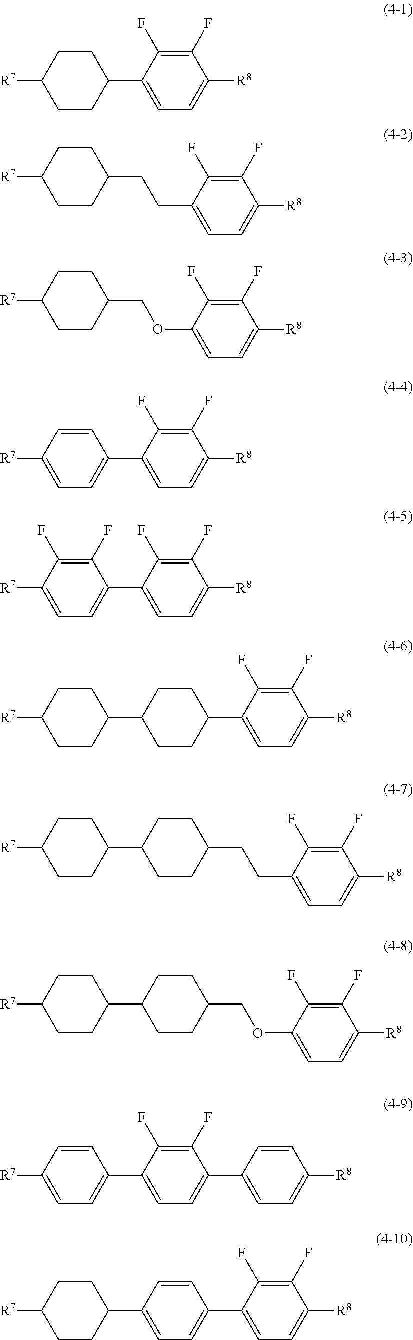

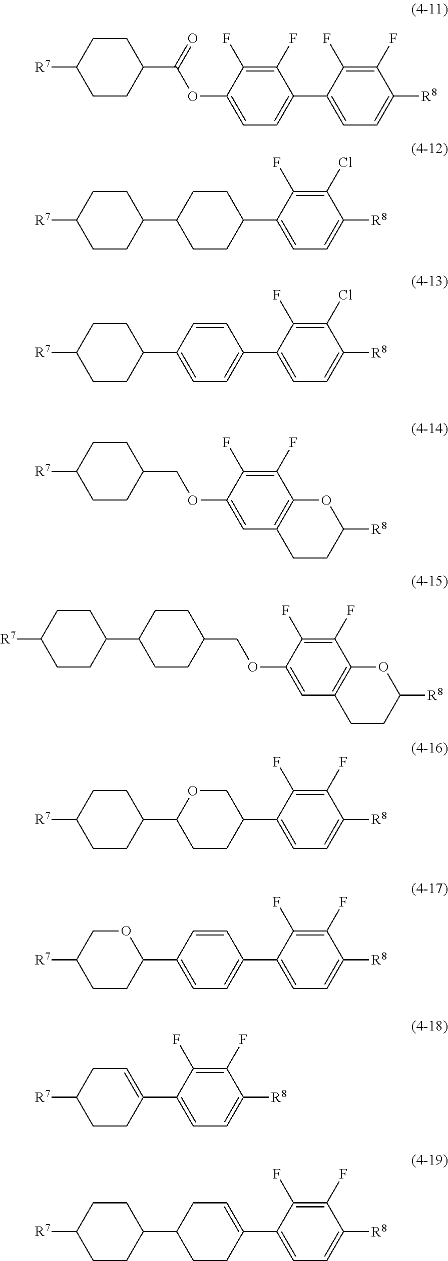

wherein, in formula (4-1) to formula (4-19), R⁷ and R⁸ are independently alkyl having 1 to 12 carbons, alkoxy having 1 to 12 carbons, alkenyl having 2 to 12 carbons, alkenyloxy having 2 to 12 carbons, or alkyl having 1 to 12 carbons in which at least one of hydrogen is replaced by fluorine or chlorine.

Item 9. The liquid crystal composition according to item 7 or 8, wherein a ratio of the fourth component is in the range of 15% by weight to 80% by weight based on the weight of the liquid crystal composition.

Item 10. The liquid crystal composition according to any one of items 1 to 9, containing at least one polymerizable compound selected from the group consisting of compounds represented by formula (5) as an additive component:

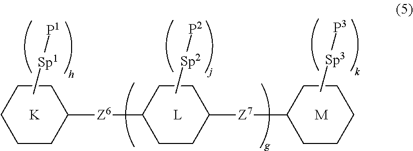

wherein, in formula (5), ring K and ring M are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one of hydrogen may be replaced by fluorine, chlorine, alkyl having 1 to 12 carbons, alkoxy having 1 to 12 carbons, or alkyl having 1 to 12 carbons in which at least one of hydrogen is replaced by fluorine or chlorine; ring L is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2, 5-diyl, and in the rings, at least one of hydrogen may be replaced by fluorine, chlorine, alkyl having 1 to 12 carbons, alkoxy having 1 to 12 carbons, or alkyl having 1 to 12 carbons in which at least one of hydrogen is replaced by fluorine or chlorine; Z⁶ and Z⁷ are independently a single bond or alkylene having 1 to 10 carbons, and in the alkylene, at least one of —CH₂— may be replaced by —O—, —CO—, —COO— or —OCO—, at least one of —CH₂—CH₂— may be replaced by —CH═CH—, —C(CH₃)═CH—, —CH═C(CH₃)— or —C(CH₃)═C(CH₃)—, and in the groups, at least one of hydrogen may be replaced by fluorine or chlorine; P¹, P² and P³ are independently a polymerizable group; Sp¹, Sp² and Sp³ are independently a single bond or alkylene having 1 to 10 carbons, and in the alkylene, at least one of —CH₂— may be replaced by —O—, —COO—, —OCO— or —OCOO—, at least one of —CH₂—CH₂— may be replaced by —CH═CH—, or —C≡C—, and in the groups, at least one of hydrogen may be replaced by fluorine or chlorine; g is 0, 1 or 2; h, j and k are independently 0, 1, 2, 3 or 4; and a sum of h, j and k is 1 or more.

Item 11. The liquid crystal composition according to item 10, wherein, in formula (5), P¹, P² and P³ are independently a polymerizable group selected from the group consisting of groups represented by formula (P-1) to formula (P-6):

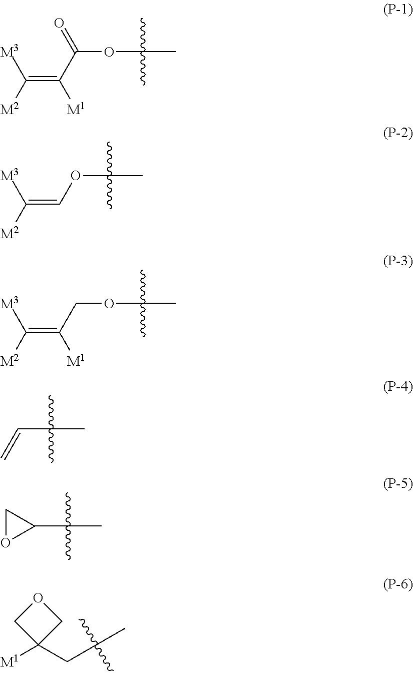

wherein, in formula (P-1) to formula (P-6), M¹, M² and M³ are independently hydrogen, fluorine, alkyl having 1 to 5 carbons, or the alkyl having 1 to 5 carbons in which at least one of hydrogen is replaced by fluorine or chlorine; and in formula (5), when all of h pieces of P¹ and k pieces of P³ are a group represented by formula (P-4), at least one of h pieces of Sp¹ and k pieces of Sp³ is alkylene in which at least one of —CH₂— is replaced by —O—, —COO—, —OCO—, or —OCOO—.

Item 12. The liquid crystal composition according to any one of items 1 to 11, containing least one polymerizable compound selected from the group consisting of compounds represented by formula (5-1) to formula (5-27) as the additive component:

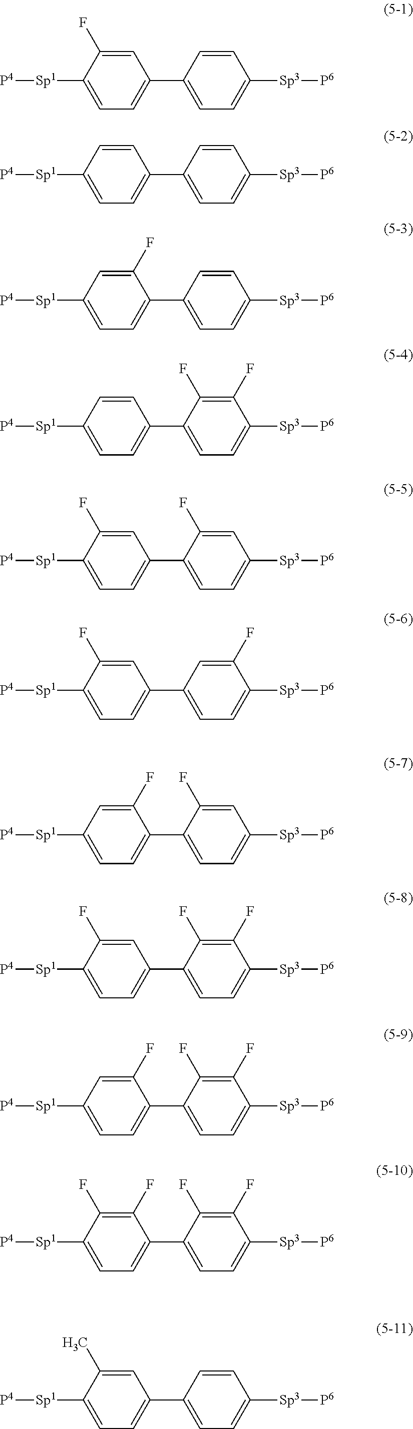

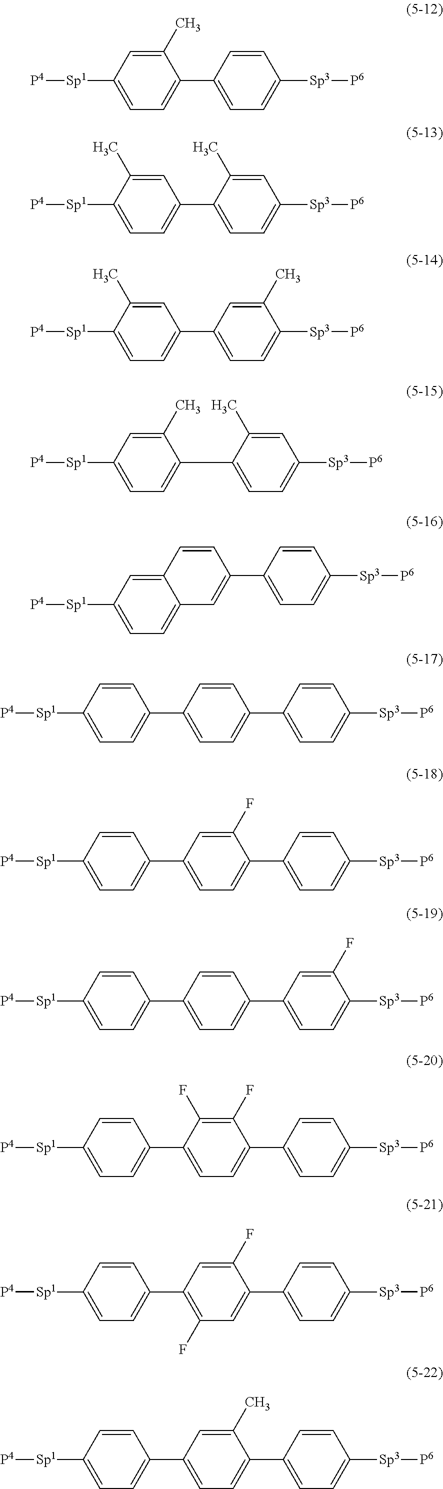

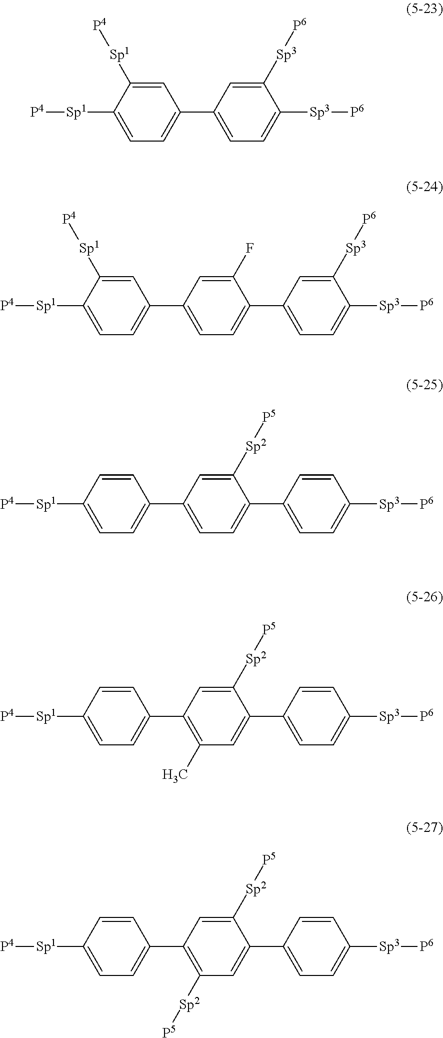

wherein, in formula (5-1) to formula (5-27), P⁴, P⁵ and P⁶ are independently a polymerizable group selected from the group consisting of groups represented by formula (P-1) to formula (P-3):

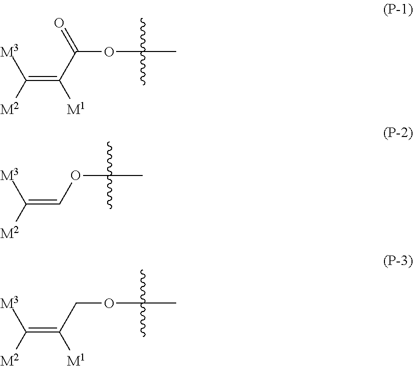

wherein, in formula (P-1) to formula (P-3), M¹, M² and M³ are independently hydrogen, fluorine, alkyl having 1 to 5 carbons, or alkyl having 1 to 5 carbons in which at least one of hydrogen is replaced by fluorine or chlorine; and
in formula (5-1) to formula (5-27), Sp¹, Sp² and Sp³ are independently a single bond or alkylene having 1 to 10 carbons, and in the alkylene, at least one of —CH₂— may be replaced by —O—, —COO—, —OCO— or —OCOO—, at least one of —CH₂—CH₂— may be replaced by —CH═CH— or —C≡C—, and in the groups, at least one of hydrogen may be replaced by fluorine or chlorine.

Item 13. The liquid crystal composition according to any one of items 10 to 12, wherein a ratio of the additive component is in the range of 0.03% by weight to 10% by weight based on the weight of the liquid crystal composition.

Item 14. A liquid crystal display device including the liquid crystal composition according to any one of items 1 to 13.

Item 15. The liquid crystal display device according to item 14, wherein an operating mode in the liquid crystal display device includes an IPS mode, a VA mode, an FFS mode or an FPA mode, and a driving mode in the liquid crystal display device includes an active matrix mode.

Item 16. A polymer sustained alignment mode liquid crystal display device, wherein the liquid crystal display device includes the liquid crystal composition according to any one of items 10 to 13, or a polymerizable compound in the liquid crystal composition is polymerized.

Item 17. Use of the liquid crystal composition according to any one of items 1 to 13 in a liquid crystal display device.

Item 18. Use of the liquid crystal composition according to any one of items 10 to 13 in a polymer sustained alignment mode liquid crystal display device.

The invention further includes the following items: (a) the composition, further containing at least one additive such as the optically active compound, the antioxidant, the ultraviolet light absorber, the dye, the antifoaming agent, the polymerizable compound, the polymerization initiator and the polymerization inhibitor; (b) an AM device including the composition; (c) a polymer sustained alignment (PSA) mode AM device, including the composition further containing the polymerizable compound; (d) the polymer sustained alignment (PSA) mode AM device, including the composition in which the polymerizable compound in the liquid crystal composition is polymerized: (e) a device including the composition and having a PC mode, a TN mode, an STN mode, an ECB mode, an OCB mode, an IPS mode, a VA mode, an FFS mode or an FPA mode; (f) a transmissive device, including the composition; (g) use of the composition as a composition having a nematic phase; and (h) use of an optically active composition by adding the optically active compound to the composition.

The composition of the invention will be described in the following order. First, a constitution of component compounds in the composition will be described. Second, main characteristics of the component compounds and main effects of the compounds on the composition are described. Third, a combination of components in the composition, a preferred ratio of the components and the basis thereof will be described. Fourth, a preferred embodiment of the component compounds will be described. Fifth, specific examples of the component compounds are shown. Sixth, an additive may be mixed with the composition will be described. Seventh, methods for synthesizing the component compounds are described. Last, an application of the composition will be described.

First, the constitution of the component compounds in the composition will be described. The composition of the invention is classified into composition A and composition B. Composition A may further contain any other liquid crystal compound, an additive or the like in addition to the liquid crystal compound selected from compound (1), compound (2), compound (3) and compound (4). “Any other liquid crystal compound” means a liquid crystal compound different from compound (1), compound (2), compound (3) and compound (4). Such a compound is mixed with the composition for the purpose of further adjusting the characteristics. The additive is the optically active compound, the antioxidant, the ultraviolet light absorber, the dye, the antifoaming agent, the polymerizable compound, the polymerization initiator, the polymerization inhibitor or the like.

Composition B consists essentially of liquid crystal compounds selected from compound (1), compound (2), compound (3) and compound (4). An expression “essentially” means that the composition may contain the additive, but does not contain any other liquid crystal compound. Composition B has a smaller number of components than composition A has. Composition B is preferred to composition A in view of cost reduction. Composition A is preferred to composition B in view of possibility of further adjusting physical properties by mixing with other liquid crystal compounds.

Second, the main characteristics of the component compounds and the main effects of the compounds on the characteristics of the composition will be described. The main characteristics of the component compounds are summarized in Table 2 on a basis of advantageous effects of the invention. In Table 2, a symbol L stands for “large” or “high,” a symbol M stands for “medium” and a symbol S stands for “small” or “low.” The symbols L, M, and S represent a classification based on a qualitative comparison among the component compounds, and 0(zero) means “a value is zero or nearly zero”.

TABLE 2
Characteristics of Compounds

| Compounds | (1) | (2) | (3) | (4) |
|---|---|---|---|---|
| Maximum temperature | S to L | S to M | S to L | S to L |
| Viscosity | M to L | S | S to M | M to L |
| Optical anisotropy | M to L | S | S to L | M to L |
| Dielectric anisotropy | L¹⁾ | 0 | 0 | M to L¹⁾ |
| Specific resistance | L | L | L | L |

¹⁾A value of dielectric anisotropy is negative, and the symbol shows magnitude of an absolute value.

Upon mixing the component compounds with the composition, the main effects of the component compounds on the characteristics of the composition are as described below. Compound (1) increases the dielectric anisotropy. Compound (2) decreases the viscosity. Compound (3) decreases the viscosity or increases the maximum temperature. Compound (4) increases the dielectric anisotropy and decreases the minimum temperature. Compound (5) gives the polymer by polymerization, and the polymer shortens a response time in the device, and improves image persistence.

Third, the combination of components in the composition, the preferred ratio of the components and the basis thereof will be described. The preferred combination of components in the composition includes a combination of the first component and the second component, a combination of the first component, the second component and the third component, a combination of the first component, the second component, and the forth component, a combination of the first component, the second component and the additive component, a combination of the first component, the second component, the third component and the fourth component, a combination of the first component, the second component, the third component and the additive component, a combination of the first component, the second component, the fourth component and the additive component, or a combination of the first component, the second component, the third component, the fourth component and the additive component. A further preferred combination of components includes a combination of the first component, the second component and the third component, a combination of the first component, the second component, the third component and the fourth component, a combination of the first component, the second component, the third component and the additive component, or a combination of the first component, the second component, the third component, the fourth component and the additive component.

A preferred ratio of the first component is approximately 3% by weight or more for increasing the dielectric anisotropy, and approximately 30% by weight or less for decreasing the viscosity, based on the weight of the liquid crystal composition. A further preferred ratio is in the range of approximately 3% by weight to approximately 25% by weight based thereon. A particularly preferred ratio is in the range of approximately 5% by weight to approximately 20% by weight based thereon.

A preferred ratio of the second component is approximately 5% by weight or more for decreasing the viscosity, and approximately 60% by weight or less for increasing the dielectric anisotropy, based on the weight of the liquid crystal composition. A further preferred ratio is in the range of approximately 10% by weight to approximately 55% by weight based thereon. A particularly preferred ratio is in the range of approximately 15% by weight to approximately 50% by weight based thereon.

A preferred ratio of the third component is approximately 5% by weight or more for increasing the maximum temperature or decreasing the viscosity, and approximately 50% or less for increasing the dielectric anisotropy, based on the weight of the liquid crystal composition. A further preferred ratio is in the range of about 5% by weight to about 45% by weight based thereon. A particularly preferred ratio is in the range of approximately 5% by weight to approximately 40% by weight based thereon.

A preferred ratio of the fourth component is approximately 15% by weight or more for increasing the dielectric anisotropy, and approximately 80% by weight or less for decreasing the minimum temperature, based on the weight of the liquid crystal composition. A further preferred ratio is in the range of approximately 20% by weight to approximately 75% by weight based thereon. A particularly preferred ratio is in the range of approximately 25% by weight to approximately 70% by weight based thereon.

Compound (5) is mixed with the composition to be adapted for the device having the polymer sustained alignment mode. A preferred ratio of the additive is approximately 0.03% by weight or more for aligning liquid crystal molecules, and approximately 10% by weight or less for preventing a poor display in the device, based on the weight of the liquid crystal composition. A further preferred addition ratio is in the range of approximately 0.1% by weight to approximately 2% by weight based thereon. A particularly preferred ratio is in the range of approximately 0.2% by weight to approximately 1.0% by weight based thereon.

Fourth, the preferred embodiment of the component compounds will be described. In formula (1), formula (2), formula (3) and formula (4), R¹ and R² are independently hydrogen, fluorine, chlorine, alkyl having 1 to 12 carbons, alkenyl having 2 to 12 carbons, alkenyloxy having 2 to 12 carbons, alkyl having 1 to 12 carbons in which at least one of hydrogen is replaced by fluorine or chlorine, or alkenyl having 2 to 12 carbons in which at least one of hydrogen is replaced by fluorine or chlorine. Preferred R¹ or R² is alkyl having 1 to 12 carbons for increasing the stability, and alkoxy having 1 to 12 carbons for increasing the dielectric anisotropy. R³ and R⁴ are independently alkyl having 1 to 12 carbons, alkenyl having 2 to 12 carbons, alkyl having 1 to 12 carbons in which at least one of hydrogen is replaced by fluorine or chlorine, or alkenyl having 2 to 12 carbons in which at least one of hydrogen is replaced by fluorine or chlorine. Preferred R³ or R⁴ is alkenyl having 2 to 12 carbons for decreasing the viscosity, or alkyl having 1 to 12 carbons for increasing the stability. R⁵ and R⁶ are independently alkyl having 1 to 12 carbons, alkoxy having 1 to 12 carbons, alkenyl having 2 to 12 carbons, alkyl having 1 to 12 carbons in which at least one of hydrogen is replaced by fluorine or chlorine, or alkenyl having 2 to 12 carbons in which at least one of hydrogen is replaced by fluorine or chlorine. Preferred R⁵ or R⁶ is alkenyl having 2 to 12 carbons for decreasing the viscosity, or alkyl having 1 to 12 carbons for increasing the stability. R⁷ and R⁸ are independently alkyl having 1 to 12 carbons, alkoxy having 1 to 12 carbons, alkenyl having 2 to 12 carbons, alkenyloxy having 2 to 12 carbons, or alkyl having 1 to 12 carbons in which at least one of hydrogen is replaced by fluorine or chlorine. Preferred R⁷ or R⁸ is alkyl having 1 to 12 carbons for increasing the stability, and alkoxy having 1 to 12 carbons for increasing the dielectric anisotropy.

In R¹ to R⁸, alkyl has a straight chain or branched chain, and contains no cyclic alkyl. Straight-chain alkyl is preferred to branched-chain alkyl. A same rule also applies to alkoxy, alkenyl, alkenyloxy, alkyl in which hydrogen is replaced by fluorine or chlorine, or alkenyl in which hydrogen is replaced by fluorine or chlorine.

Preferred alkyl is methyl, ethyl, propyl, butyl, pentyl, hexyl, heptyl or octyl. Further preferred alkyl is ethyl, propyl, butyl, pentyl or heptyl for decreasing the viscosity.

Preferred alkoxy is methoxy, ethoxy, propoxy, butoxy, pentyloxy, hexyloxy or heptyloxy. Further preferred alkoxy is methoxy or ethoxy for decreasing the viscosity.

Preferred alkenyl is vinyl, 1-propenyl, 2-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl or 5-hexenyl. Further preferred alkenyl is vinyl, 1-propenyl, 3-butenyl or 3-pentenyl for decreasing the viscosity. A preferred configuration of —CH═CH— in alkenyl depends on a position of a double bond. Trans is preferred in alkenyl such as 1-propenyl, 1-butenyl, 1-pentenyl, 1-hexenyl, 3-pentenyl and 3-hexenyl for decreasing the viscosity, for instance. Cis is preferred in alkenyl such as 2-butenyl, 2-pentenyl, and 2-hexenyl. In the alkenyl, straight-chain alkenyl is preferred to branched-chain alkenyl.

Preferred alkenyloxy is vinyloxy, allyloxy, 3-butenyloxy, 3-pentenyloxy or 4-pentenyloxy. Further preferred alkenyloxy is allyloxy or 3-butenyloxy for decreasing the viscosity.

A preferred example of alkenyl in which at least one of hydrogen is replaced by fluorine, or chlorine includes 2,2-difluorovinyl, 3-difluoro-2-propenyl, 4,4-difluoro-3-butenyl, 5-difluoro-4-pentenyl or 6,6-difluoro-5-hexenyl. A further preferred example includes 2,2-difluorovinyl or 4,4-difluoro-3-butenyl for decreasing the viscosity.

A, B, and C are independently 1,4-cyclohexylene, 1,4-cyclohexenylene, 1,4-phenylene, or 1,4-phenylene in which at least one of hydrogen is replaced by fluorine or chlorine, or tetrahydropyran-2,5-diyl, naphthalene-2,6-diyl, naphthalene-2,6-diyl in which at least one of hydrogen is replaced by fluorine or chlorine, chroman-2,6-diyl, or chroman-2.6-diyl in which at least one of hydrogen is replaced by fluorine or chlorine. A preferred example of “1,4-phenylene in which at least one of hydrogen is replaced by fluorine or chlorine” includes 2-fluoro-1,4-phenylene, 2,3-difluoro-1,4-phenylene or 2-chloro-3-fluoro-1,4-phenylene. Preferred A, B or C is 1,4-cyclohexylene for decreasing the viscosity, tetrahydropyran-2,5-diyl for increasing the dielectric anisotropy, and 1,4-phenylene for increasing the optical anisotropy. With regard to a configuration of 1,4-cyclohexylene, trans is preferred to cis for increasing the maximum temperature. Tetrahydropyran-2,5-diyl includes:

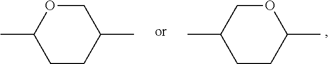

and preferably,

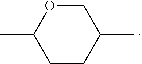

Ring D and ring E are independently 1,4-cyclohexylene, 1,4-phenylene, 2-fluoro-1,4-phenylene or 2,5-difluoro-1,4-phenylene. Preferred ring D or ring E is 1,4-cyclohexylene for decreasing the viscosity or increasing the maximum temperature, or 1,4-phenylene for decreasing the minimum temperature. Ring F and ring J are independently 1,4-cyclohexylene, 1,4-cyclohexenylene, tetrahydropyran-2,5-diyl, 1,4-phenylene, or 1,4-phenylene in which at least one of hydrogen is replaced by fluorine or chlorine. Preferred ring F or ring J is 1,4-cyclohexylene for decreasing the viscosity, 1,4-phenylene for decreasing the minimum temperature, or tetrahydropyran-2,5-diyl for increasing the dielectric anisotropy. Ring G is 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl or 8-difluorochroman-2,6-diyl. Preferred ring G is 2,3-difluoro-1,4-phenylene for decreasing the viscosity, 2-chloro-3-fluoro-1,4-phenylene for decreasing the optical anisotropy, or 7,8-difluorochroman-2,6-diyl for increasing the dielectric anisotropy.

Z¹, Z², Z⁴ and Z⁵ are independently a single bond, ethylene, carbonyloxy or methyleneoxy. Preferred Z¹, Z², Z³, Z⁴ or Z⁵ is a single bond for decreasing the viscosity, ethylene for decreasing the minimum temperature, or methyleneoxy for increasing the dielectric anisotropy. Z³ is a single bond, ethylene or carbonyloxy. Preferred Z² is a single bond for increasing the stability.

Y¹ is —CF₂H or —CF₃. Preferred Y¹ is —CF₂H. Y² is hydrogen, fluorine, chlorine, —CFH₂, —CF₂H or —CF₃. Preferred Y¹ is hydrogen for decreasing the viscosity, or fluorine for increasing the dielectric anisotropy.

Then, a, b and d are independently 0, 1, 2 or 3, and in formula (1), a sum of a, b and d is 3 or less, and in formula (1-1), a sum of a and b is 1, 2 or 3. Preferred a or b is 0 for decreasing the viscosity, or 1 for increasing the maximum temperature. Preferred d is 0 for decreasing the viscosity, or 1 or 2 for increasing the maximum temperature. Then, c is 0, 1, 2, 3, 4, 5, 6, 7, 8, 9 or 10. Preferred c is 1, 2 or 3. Then, e is 1, 2, 3, 4 or 5. Preferred e is 1, 2 or 3. Then, n is 1, 2 or 3, and ring E when n is 1 herein is 1,4-phenylene. Preferred n is 1 for decreasing the viscosity, or 2 or 3 for increasing the maximum temperature. Then, p is 1, 2 or 3, q is 0 or 1, and a sum of p and q is 3 or less. Preferred p is 1 for decreasing the viscosity, or 2 or 3 for increasing the maximum temperature. Preferred q is 0 for decreasing the viscosity, or 1 for decreasing the minimum temperature.

In formula (5) and formula (5-1) to formula (5-27), Sp¹, Sp² and Sp³ are independently a single bond or alkylene having 1 to 10 carbons, and in the alkylene, at least one of —CH₂— may be replaced by —O—, —COO—, —OCO— or —OCOO—, at least one of —CH₂—CH₂— may be replaced by —CH═CH— or —C≡C—, and in the groups, at least one of hydrogen may be replaced by fluorine or chlorine. Preferred Sp¹, Sp² or Sp³ is a single bond.

In formula (5), P¹, P² and P³ are a polymerizable group. Preferred P¹, P² or P³ is a polymerizable group selected from the group consisting of groups represented by formula (P-1) to formula (P-6). Further preferred P¹, P² or P³ is group (P-1) or group (P-2). Particularly preferred group (P-1) is —OCO—CH═CH₂ or —OCO—C(CH₃)═CH₂. A wavy line in group (P-1) to group (P-6) represents a part to be bonded:

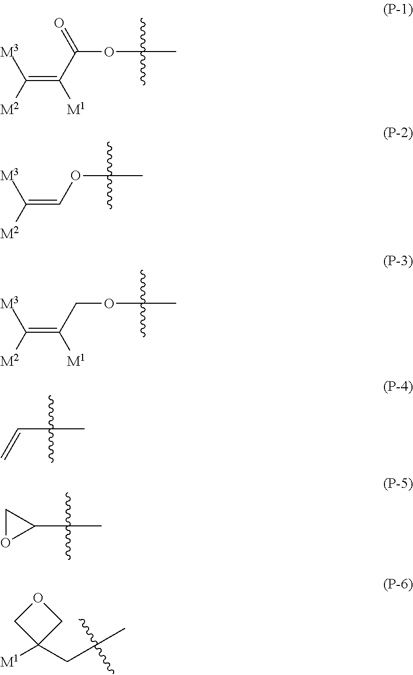

In group (P-1) to group (P-6), M¹, M² and M³ are independently hydrogen, fluorine, alkyl having 1 to 5 carbons, or alkyl having 1 to 5 carbons in which at least one of hydrogen is replaced by halogen. Preferred M¹, M² or M³ is hydrogen or methyl for increasing reactivity. Further preferred M¹ is methyl, and further preferred M² or M³ is hydrogen. When at least two of h pieces of P¹, g×j pieces of P² and k pieces of P³ are group (P-1), two of arbitrary M¹, M² or M³ in P¹, P² and P³ may be identical or different. A same rule also applied to a case where at least two thereof is group (P-2) or group (P-3).

When all of h pieces of P¹ and k pieces of P³ are group (P-4), at least one of h pieces of Sp¹ and k pieces of Sp³ is alkylene in which at least one of —CH₂— is replaced by —O—, —COO—, —OCO— or —OCOO—. More specifically, a case where all of h pieces of P¹ and k pieces of P³ are alkenyl such as 1-propenyl is excluded.

In formula (5-1) to formula (5-27), P⁴, P⁵ and P⁶ are independently a group represented by formula (P-1) to formula (P-3). Preferred P⁴, P⁵ or P⁶ is group (P-1) or group (P-2). Further preferred group (P-1) is —OCO—CH═CH₂ or —OCO—C(CH₃)═CH₂. A wavy line in group (P-1) to group (P-3) represents a part to be bonded:

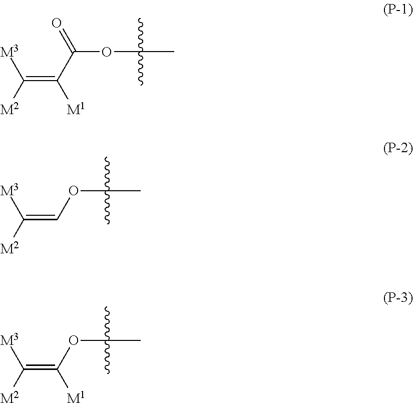

When at least two of one or two of P⁴, one or two of P⁵, and one or two of P⁶ are group (P-1), two of arbitrary M¹, M² or M³ in P⁴, P⁵ and P⁶ may be identical or different. A same rule also applies to a case where at least two thereof is group (P-2) or group (P-3).

Ring K and ring M are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one of hydrogen may be replaced by halogen, alkyl having 1 to 12 carbons, alkoxy having 1 to 12 carbons, or alkyl having 1 to 12 carbons in which at least one of hydrogen is replaced by halogen. Preferred ring K or ring M is phenyl. Ring L is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in the rings, at least one of hydrogen may be replaced by halogen, alkyl having 1 to 12 carbons, alkoxy having 1 to 12 carbons, or alkyl having 1 to 12 carbons in which at least one of hydrogen is replaced by halogen. Preferred ring L is 1,4-phenylene or 2-fluoro-1,4-phenylene.

Z⁶ and Z⁷ are independently a single bond or alkylene having 1 to 10 carbons, and in the alkylene, at least one of —CH₂— may be replaced by —O—, —CO—, —COO— or —OCO—, at least one of —CH₂—CH₂— may be replaced by CH═CH—, —C(CH₃)═CH—, —CH═C(CH₃)— or —C(CH₃)═C(CH₃)—, and in the groups, at least one of hydrogen may be replaced by fluorine or chlorine. Preferred Z⁶ or Z⁷ is a single bond, —CH₂CH₂—, —CH₂O—, —OCH₂—, —COO— or —OCO—. Further preferred Z⁶ or Z⁷ is a single bond.

Then, g is 1, 2 or 3. Preferred g is 0 or 1. Then, h, j and k are independently 0, 1, 2, 3 or 4, and a sum of h, j and k is 1 or more. Preferred h, j or k is 1 or 2.

Fifth, the preferred embodiment of the component compounds will be described. Preferred compound (1) includes compound (1-1) and compound (1-2) as described in item 2.

Preferred compound (3) includes compound (3-1) to compound (3-12) as described in item 5. In the compounds, at least one of the third components preferably includes compound (3-1), compound (3-2), compound (3-4), compound (3-5), compound (3-6) or compound (3-12). At least two of the third components preferably include a combination of compound (3-1) and compound (3-4), a combination of compound (3-2) and compound (3-4), or a combination of compound (3-2) and compound (3-5).

Preferred compound (4) includes compound (4-1) to compound (4-19) as described in item 8. In the compounds, at least one of the fourth components preferably includes compound (4-1), compound (4-2), compound (4-3), compound (4-4), compound (4-6), compound (4-7), compound (4-8) or compound (4-10). At least two of the fourth components preferably include a combination of compound (4-1) and compound (4-6), a combination of compound (4-3) and compound (4-8), a combination of compound (4-3) and compound (4-6), a combination of compound (4-3) and compound (4-10), a combination of compound (4-4) and compound (4-6), or a combination of compound (4-4) and compound (4-10).

Preferred compound (5) includes compound (5-1) to compound (5-27) as described in item 12. In the compounds, at least one of the additive components preferably includes compound (5-1), compound (5-2), compound (5-24), compound (5-25), compound (5-26) or compound (5-27). At least two of the additive components preferably include a combination of compound (5-1) and compound (5-2), a combination of compound (5-1) and compound (5-18), a combination of compound (5-2) and compound (5-24), a combination of compound (5-2) and compound (5-25), a combination of compound (5-2) and compound (5-26), a combination of compound (5-25) and compound (5-26), or a combination of compound (5-18) and compound (5-24). In group (P-1) to group (P-3), preferred M¹, M² or M³ is hydrogen or methyl. Preferred Sp¹, Sp² or Sp³ is a single bond, —CH₂CH₂—, —CH₂O—, —OCH₂—, —COO—, —OCO—, —CO—CH═CH— or —CH═CH—CO—.

Sixth, the additive that may be added to the composition will be described. The additive is the optically active compound, the antioxidant, the ultraviolet light absorber, the dye, the antifoaming agent, the polymerizable compound, the polymerization initiator, the polymerization inhibitor or the like. The optically active compound is mixed with the composition for inducing a helical structure in a liquid crystal to give a twist angle. Examples of such a compound include compound (6-1) to compound (6-5). A preferred ratio of the optically active compound is approximately 5% by weight or less based on the weight of the liquid crystal composition. A further preferred ratio is in the range of approximately 0.01% by weight to approximately 2% by weight based thereon:

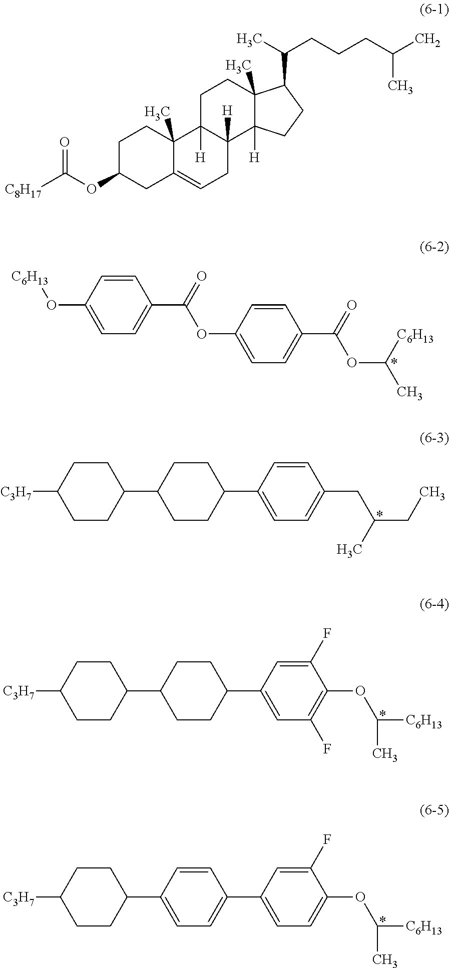

The antioxidant is mixed with the composition for preventing a decrease in the specific resistance caused by being heated in air, or for maintaining the large voltage holding ratio at room temperature and also at the temperature close to the maximum temperature of the nematic phase even after the device has been used for a long period of time. A preferred example of the antioxidant includes compound (7) where n is an integer from 1 to 9.

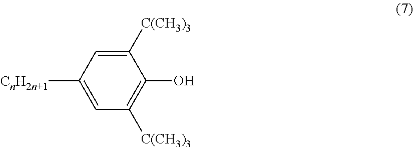

In compound (7), preferred n is 1, 3, 5, 7 or 9. Further preferred n is 7. Compound (7) where t is 7 is effective for maintaining the large voltage holding ratio at room temperature and also at the temperature close to the maximum temperature of the nematic phase even after the device has been used for a long period of time because the above compound (7) has a small volatility. A preferred ratio of the antioxidant is approximately 50 ppm or more for achieving the effect thereof, and approximately 600 ppm or less for avoiding a decrease in the maximum temperature or an increase in the minimum temperature. A further preferred ratio is in the range of approximately 100 ppm to approximately 300 ppm.

A preferred example of the ultraviolet light absorber includes a benzophenone derivative, a benzoate derivative and a triazole derivative. A light stabilizer such as an amine having steric hindrance is also preferred. A preferred ratio of the absorber or the stabilizer is approximately 50 ppm or more for achieving the effect thereof, and approximately 10,000 ppm or less for avoiding a decrease in the maximum temperature or avoiding an increase in the minimum temperature. A further preferred ratio is in the range of approximately 100 ppm to approximately 10,000 ppm.

A dichroic dye such as an azo dye or an anthraquinone dye is mixed with the composition to be adapted for a device having a guest host (GH) mode. A preferred ratio of the dye is in the range of approximately 0.01% by weight to approximately 10% by weight based on the weight of the liquid crystal composition. The antifoaming agent such as dimethyl silicone oil or methyl phenyl silicone oil is mixed with the composition for preventing foam formation. A preferred ratio of the antifoaming agent is approximately 1 ppm or more for achieving the effect thereof, and approximately 1,000 ppm or less for avoiding a poor display. A further preferred ratio is in the range of approximately 1 ppm to approximately 500 ppm.

The polymerizable compound is used to be adapted for a device having the polymer sustained alignment (PSA) mode. Compound (5) is suitable for the purpose. A polymerizable compound different from compound (5) may be mixed with the composition together with compound (5). A preferred example of such a polymerizable compound includes a compound such as an acrylate, a methacrylate, a vinyl compound, a vinyloxy compound, a propenyl ether, an epoxy compound (oxirane, oxetane) and a vinyl ketone. A further preferred example includes an acrylate derivative or a methacrylate derivative. A preferred ratio of compound (5) is approximately 10% by weight or more based on the total weight of the polymerizable compound. A further preferred ratio is 50% by weight or more based thereon. A particularly preferred ratio is 80% by weight or more based thereon. A most preferred ratio is approximately 100% by weight based thereon.

The polymerizable compound such as compound (5) is polymerized by irradiation with ultraviolet light. The polymerizable compound such as compound (5) maybe polymerized in the presence of a suitable initiator such as a photopolymerization initiator. Suitable conditions for polymerization, suitable types of the initiator, and suitable amounts thereof are known to those skilled in the art and are described in literature. For example, Irgacure 651 (registered trademark; BASF), Irgacure 184 (registered trademark; BASF) or Darocur 1173 (registered trademark; BASF), each being a photoinitiator, is suitable for radical polymerization. A preferred ratio of the photopolymerization initiator is in the range of approximately 0.1% by weight to approximately 5% by weight based on the total weight of the polymerizable compound. A further preferred ratio is in the range of approximately 1% by weight to approximately 3% by weight based thereon.

Upon storing the polymerizable compound such as compound (5), the polymerization inhibitor may be added thereto for preventing polymerization. The polymerizable compound is ordinarily added to the composition without removing the polymerization inhibitor. An example of the polymerization inhibitor includes hydroquinone, a hydroquinone derivative such as methylhydroquinone, 4-tert-butylcatechol, 4-methoxyphenol and phenothiazine.

Seventh, the methods for synthesizing the component compounds will be described. The compounds can be prepared by known methods. Examples of synthetic methods are described. Compound (1-1) is prepared by a method described in JP 2002-193852 A. Compound (2) is prepared by a method described in JP S57-114532 A. Compound (3-4) is prepared by a method described in JP S59-176221 A. Compound (4-1) is prepared by a method described in JP H2-503441 A. Compound (5-18) is prepared by a method described in JP H7-101900 A. A compound where n in formula (7) is 1 can be obtained from Sigma-Aldrich Corporation. A compounds where n in compound (7) is 7 can be prepared according to a method described to U.S. Pat. No. 3,660,505 B.

Any compounds whose synthetic methods are not described can be prepared according to methods described in books such as Organic Syntheses (John Wiley & Sons, Inc.), Organic Reactions (John Wiley & Sons, Inc.), Comprehensive Organic Synthesis (Pergamon Press) and New Experimental Chemistry Course (Shin Jikken Kagaku Koza in Japanese) (Maruzen Co., Ltd.). The composition is prepared according to publicly known methods using the thus obtained compounds. For example, the component compounds are mixed and dissolved in each other by heating.

Last, the application of the composition will be described. The composition of the invention mainly has a minimum temperature of approximately −10° C. or lower, a maximum temperature of approximately 70° C. or higher, and an optical anisotropy in the range of approximately 0.07 to approximately 0.20. A device including the composition has a large voltage holding ratio. The composition is suitable for use in the AM device. The composition is particularly suitable for use in a transmissive AM device. A composition having an optical anisotropy in the range of approximately 0.08 to approximately 0.25, and also a composition having an optical anisotropy in the range of approximately 0.10 to approximately 0.30 may be prepared by controlling a ratio of the component compounds or by mixing with any other liquid crystal compound. The composition can be used as the composition having the nematic phase, and as the optically active composition by adding the optically active compound.

The composition can be used for the AM device. The composition can also be used for a PM device. The composition can also be used for an AM device and a PM device each having the mode such as the PC mode, the TN mode, the STN mode, the ECB mode, the OCB mode, the IPS mode, the FFS mode, the VA mode and the FPA mode. Use for the AM device having the TN mode, the OCB mode, the IPS mode or the FFS mode is particularly preferred. In the AM device having the IPS mode or the FFS mode, alignment of liquid crystal molecules when no voltage is applied may be parallel or vertical to a glass substrate. The devices may be of a reflective type, a transmissive type or a transreflective type. Use for the transmissive device is preferred. Use for an amorphous silicon-TFT device or a polycrystal silicon-TFT device is allowed. Use for a nematic curvilinear aligned phase (NCAP) device prepared by microencapsulating the composition, or for a polymer dispersed (PD) device in which a three-dimensional network-polymer is formed in the composition is allowed.

It will be apparent to those skilled in the art that various modifications and variations can be made in the invention and specific examples provided herein without departing from the spirit or scope of the invention. Thus, it is intended that the invention covers the modifications and variations of this invention that come within the scope of any claims and their equivalents.

The following examples are for illustrative purposes only and are not intended, nor should they be interpreted to, limit the scope of the invention.

### EXAMPLES

The invention will be described in greater detail by way of Examples. However, the invention is not limited by the Examples. The invention includes a mixture of a composition in Example 1 and a composition in Example 2. The invention also includes a mixture in which at least two compositions in Examples are mixed. The thus prepared compound was identified by methods such as an NMR analysis. Characteristics of the compound and the composition were measured by methods described below.

NMR analysis: As a measuring apparatus, DRX-500 made by Bruker BioSpin Corporation was used. In ¹H-NMR measurement, a sample was dissolved in a deuterated solvent such as CDCl₃, and measurement was carried out under conditions of room temperature, 500 MHZ and 16 times of accumulation. Tetramethylsilane (TMS) was used as an internal standard. In ¹⁹F-NMR measurement, CFCl₃ was used as an internal standard, and measurement was carried out under conditions of 24 times of accumulation. In explaining nuclear magnetic resonance spectra obtained, s, d, t, q, quin, sex, m and r stand for a singlet, a doublet, a triplet, a quartet, a quintet, a sextet, a multiplet, and br being broad, respectively.

Gas chromatographic analysis: GC-14B Gas Chromatograph made by Shimadzu Corporation was used for measurement. A carrier gas was helium (2 mL per minute). A sample injector and a detector (FID) were set to 280° C. and 300° C., respectively. A capillary column DB-1 (length 30 m, bore 0.32 mm, film thickness 0.25 μm; dimethylpolysiloxane as a stationary phase, non-polar) made by Agilent Technologies, Inc. was used for separation of component compounds. After the column was kept at 200° C. for 2 minutes, the column was heated to 280° C. at a rate of 5° C. per minute. A sample was prepared in an acetone solution (0.1% by weight), and then 1 microliter of the solution was injected into the sample injector. A recorder was C-R5A Chromatopac made by Shimadzu Corporation or the equivalent thereof. The resulting gas chromatogram showed a retention time of a peak and a peak area corresponding to each of the component compounds.

As a solvent for diluting the sample, chloroform, hexane or the like may also be used. The following capillary columns may also be used for separating the component compounds: HP-1 (length 30 m, bore 0.32 mm, film thickness 0.25 μm) made by Agilent Technologies, Inc., Rtx-1 (length 30 m, bore 0.32 mm, film thickness 0.25 μm) made by Restek Corporation and BP-1 (length 30 m, bore 0.32 mm, film thickness 0.25 μm) made by SGE International Pty. Ltd. A capillary column CBP1-M50-025 (length 50 m, bore 0.25 mm, film thickness 0.25 μm) made by Shimadzu Corporation may also be used for the purpose of avoiding overlap of peaks of the compounds.

A ratio of liquid crystal compounds contained in the composition may be calculated by the method as described below. The mixture of liquid crystal compounds was detected by gas chromatograph (FID). An area ratio of each peak in the gas chromatogram corresponds to the ratio (weight ratio) of the liquid crystal compound. When the capillary columns described above were used, a correction coefficient of each of the liquid crystal compounds may be regarded as 1 (one). Accordingly, the ratio (% by weight) of the liquid crystal compound is calculated from the area ratio of each peak.

Sample for measurement: When characteristics of a composition and a device were measured, the composition was used as a sample as was. Upon measuring characteristics of a compound, a sample for measurement was prepared by mixing the compound (15% by weight) with a base liquid crystal (85% by weight). Values of characteristics of the compound were calculated, according to an extrapolation method, using values obtained by measurement: (extrapolated value)={(measured value of a sample for measurement)−0.85×(measured value of a base liquid crystal)}/0.15. When a smectic phase (or crystals) precipitates at the ratio thereof at 25° C., a ratio of the compound to the base liquid crystal was changed step by step in the order of (10% by weight:90% by weight), (5% by weight:95% by weight), and (1% by weight:99% by weight). Values of maximum temperature, optical anisotropy, viscosity and dielectric anisotropy with regard to the compound were determined according to the extrapolation method.

A base liquid crystal described below was used. A ratio of the component compound was expressed in terms of weight percent (% by weight).

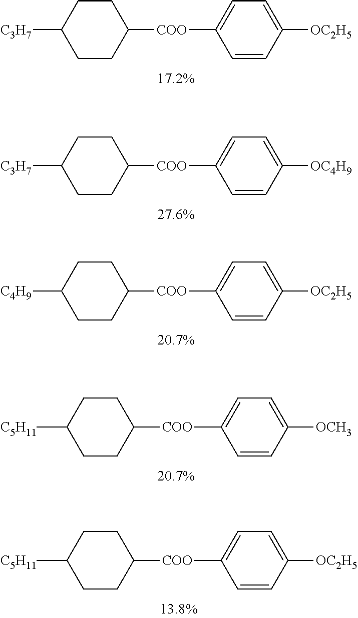

Measuring method: Measurement of characteristics was carried out by the methods described below. Most of the measuring methods are applied as described in the Standard of the Japan Electronics and Information Technology Industries Association (hereinafter abbreviated as JEITA) (JEITA EIAJ ED-2521B) discussed and established by JEITA, or modified thereon. No thin film transistor (TFT) was attached to a TN device used for measurement.

(1) Maximum temperature of a nematic phase (NI; ° C.): A sample was placed on a hot plate in a melting point apparatus equipped with a polarizing microscope, and heated at a rate of 1° C. per minute. Temperature when part of the sample began to change from a nematic phase to an isotropic liquid was measured. A higher limit of a temperature range of the nematic phase may be occasionally abbreviated as “maximum temperature.”

(2) Minimum temperature of a nematic phase (T_{c}; ° C.): Samples each having a nematic phase were put in glass vials and kept in freezers at temperatures of 0° C., −10° C., −20° C., −30° C. and −40° C. for 10 days, and then liquid crystal phases were observed. For example, when the sample maintained the nematic phase at −20° C. and changed to crystals or a smectic phase at −30° C., T_{c} of the sample was expressed as T_{c}<−20° C. A lower limit of the temperature range of the nematic phase may be occasionally abbreviated as “minimum temperature.”

(3) Viscosity (bulk viscosity; η; measured at 20° C.; mPa·s): A cone-plate (E type) rotational viscometer made by Tokyo Keiki, Inc. was used for measurement.

(4) Viscosity (rotational viscosity; γ1; measured at 25° C.; mPa·s): Measurement was carried out according to the method described in M. Imai et al., Molecular Crystals and Liquid Crystals, Vol. 259, p. 37 (1995). A sample was put in a VA device in which a distance (cell gap) between two glass substrates was 20 micrometers. Voltage was applied stepwise to the device in the range of 39 V to 50 V at an increment of 1 V. After a period of 0.2 second with no voltage application, voltage was repeatedly applied under conditions of only one rectangular wave (rectangular pulse; 0.2 second) and no voltage application (2 seconds). A peak current and a peak time of a transient current generated by the applied voltage were measured. A value of rotational viscosity was obtained from the measured values and a calculation equation (8) described on page 40 of the paper presented by M. Imai et al. Dielectric anisotropy required for the calculation was measured according to section (6) described below.

(5) Optical anisotropy (refractive index anisotropy; Δn; measured at 25° C.): Measurement was carried out by an Abbe refractometer with a polarizing plate mounted on an ocular, using light at a wavelength of 589 nanometers. A surface of a main prism was rubbed in one direction, and then a sample was added dropwise onto the main prism. A refractive index (n∥) was measured when a direction of polarized light was parallel to a direction of rubbing. A refractive index (n⊥) was measured when the direction of polarized light was perpendicular to the direction of rubbing. A value of optical anisotropy was calculated from an equation: Δn=n∥−n⊥.

(6) Dielectric anisotropy (Δε; measured at 25° C.): A value of dielectric anisotropy was calculated from an equation: Δε=ε∥−ε⊥. A dielectric constant (ε∥ and ε⊥) was measured as described below.

1) Measurement of dielectric constant (ε∥): An ethanol (20 mL) solution of octadecyl triethoxysilane (0.16 mL) was applied to a well-cleaned glass substrate. After rotating the glass substrate with a spinner, the glass substrate was heated at 150° C. for 1 hour. A sample was put in a VA device in which a distance (cell gap) between two glass substrates was 4 micrometers, and the device was sealed with an ultraviolet-curable adhesive. Sine waves (0.5 V, 1 kHz) were applied to the device, and after 2 seconds, a dielectric constant (ε∥) in the major axis direction of liquid crystal molecules was measured.

2) Measurement of dielectric constant (ε⊥): A polyimide solution was applied to a well-cleaned glass substrate. After calcining the glass substrate, rubbing treatment was applied to the alignment film obtained. A sample was put in a TN device in which a distance (cell gap) between two glass substrates was 9 micrometers and a twist angle was 80 degrees. Sine waves (0.5 V, 1 kHz) were applied to the device, and after 2 seconds, a dielectric constant (ε⊥) in the minor axis direction of the liquid crystal molecules was measured.

(7) Threshold voltage (Vth; measured at 25° C.; V): An LCD-5100 luminance meter made by Otsuka Electronics Co., Ltd. was used for measurement. A light source was a halogen lamp. A sample was put in a normally black mode VA device in which a distance (cell gap) between two glass substrates was 4 micrometers and a rubbing direction was anti-parallel, and the device was sealed with an ultraviolet-curable adhesive. A voltage (60 Hz, rectangular waves) to be applied to the device was stepwise increased from 0 V to 20 V at an increment of 0.02 V. On the occasion, the device was irradiated with light from a direction perpendicular to the device, and an amount of light transmitted through the device was measured. A voltage-transmittance curve was prepared, in which the maximum amount of light corresponds to 100% transmittance and the minimum amount of light corresponds to 0% transmittance. A threshold voltage is expressed in terms of a voltage at 10% transmittance.

(8) Voltage holding ratio (VHR-1; measured at 25° C.; %): A TN device used for measurement had a polyimide alignment film, and a distance (cell gap) between two glass substrates was 5 micrometers. A sample was put in the device, and the device was sealed with an ultraviolet-curable adhesive. A pulse voltage (60 microseconds at 5 V) was applied to the TN device and the device was charged. A decaying voltage was measured for 16.7 milliseconds with a high-speed voltmeter, and area A between a voltage curve and a horizontal axis in a unit cycle was determined. Area B is an area without decay. A voltage holding ratio is expressed in terms of a percentage of area A to area B.

(9) Voltage holding ratio (VHR-2; measured at 80° C.; %): A voltage holding ratio was measured according to procedures identical with the procedures described above except that measurement was carried out at 80° C. in place of 25° C. The thus obtained value was expressed in terms of VHR-2.

(10) Voltage holding ratio (VHR-3; measured at 25° C.; %): Stability to ultraviolet light was evaluated by measuring a voltage holding ratio after a device was irradiated with ultraviolet light. A TN device used for measurement had a polyimide alignment film and a cell gap was 5 micrometers. A sample was injected into the device, and was irradiated with light for 20 minutes. A light source was an ultra high-pressure mercury lamp USH-500D (made by Ushio, Inc.), and a distance between the device and the light source was 20 centimeters. In measurement of VHR-3, a decaying voltage was measured for 16.7 milliseconds. A composition having large VHR-3 has a large stability to ultraviolet light. A value of VHR-3 is preferably 90% or more, and further preferably, 95% or more.

(11) Voltage holding ratio (VHR-4; measured at 25° C.; %): Stability to heat was evaluated by measuring a voltage holding ratio after a TN device into which a sample was injected was heated in a constant-temperature bath at 80° C. for 500 hours. In measurement of VHR-4, a decaying voltage was measured for 16.7 milliseconds. A composition having large VHR-4 has a large stability to heat.

(12) Response Time (τ; measured at 25° C.; ms): An LCD-5100 luminance meter made by Otsuka Electronics Co., Ltd. was used for measurement. A light source was a halogen lamp. A low-pass filter was set at 5 kHz. A sample was put in a normally black mode VA device in which a distance (cell gap) between two glass substrates was 4 micrometers and a rubbing direction was anti-parallel. The device was sealed with an ultraviolet-curable adhesive. A voltage (60 Hz, rectangular waves) was applied to the device. On the occasion, the device was irradiated with light from a direction perpendicular to the device, and an amount of light transmitted through the device was measured. A voltage-transmittance curve was prepared, in which the maximum amount of light corresponds to 100% transmittance and the minimum amount of light corresponds to 0% transmittance. A response time is a period of time required for a change from 90% transmittance to 10% transmittance (fall time; millisecond).

(13) Specific resistance (ρ; measured at 25 C; Ωcm): Into a vessel equipped with electrodes, 1.0 mL of a sample was injected. A direct current voltage (10V) was applied to the vessel, and a direct current after 10 seconds was measured. Specific resistance was calculated from the following equation: (specific resistance)={(voltage)×(electric capacity of the vessel)}/{(direct current)×(dielectric constant of vacuum)}.

The compounds described in Comparative Examples and Examples were described using symbols according to definitions in Table 3 below. In Table 3, a configuration with regard to 1,4-cyclohexylene is trans. A parenthesized number next to a symbolized compound in Examples corresponds to the number of the compound. A symbol (-) means any other liquid crystal compound. A ratio (percentage) of the liquid crystal compound is expressed in terms of weight percent (% by weight) based on the weight of the liquid crystal composition. Values of characteristics of the composition were summarized in a last part.

TABLE 3
Method for Description of Compounds using Symbols
R—(A₁)—Z₁— . . . —Zₙ—(Aₙ)—R′

| 1) Left-terminal Group R— | Symbol |
|---|---|
| F—CₙH₂ₙ— | Fn— |
| CₙH₂ₙ₊₁— | n- |
| CₙH₂ₙ₊₁O— | nO— |
| CₘH₂ₘ₊₁OCₙH₂ₙ— | mOn— |
| CH₂═CH— | V— |
| CₙH₂ₙ₊₁—CH═CH— | nV— |
| CH₂═CH—CₙH₂ₙ— | Vn— |
| CₘH₂ₘ₊₁—CH═CH—CₙH₂ₙ— | mVn— |
| CF₂═CH— | VFF— |
| CF₂═CH—CₙH₂ₙ— | VFFn— |
| CH₂═CHCOO— | AC— |
| CH₂═C(CH₃)COO— | MAC— |
| CₙH₂ₙ₊₁—CO— | nK— |
| 2) Right-terminal Group —R′ | Symbol |
| —CₙH₂ₙ₊₁ | -n |
| —OCₙH₂ₙ₊₁ | —On |
| —CH═CH₂ | —V |
| —CH═CH—CₙH₂ₙ₊₁ | —Vn |
| —CₙH₂ₙ—CH═CH₂ | —nV |
| —CₘH₂ₘ—CH═CH—CₙH₂ₙ₊₁ | —mVn |
| —CH═CF₂ | —VFF |
| —OCOCH═CH₂ | —AC |
| —OCOC(CH₃)═CH₂ | —MAC |
| —CO—CₙH₂ₙ₊₁ | —Kn |
| 3) Bonding Group —Zₙ— | Symbol |
| —CₙH₂ₙ— | n |
| —COO— | E |
| —CH═CH— | V |
| —CH═CHO— | VO |
| —OCH═CH— | OV |
| —CH₂O— | 1O |
| —OCH₂— | O1 |
| —CₙH₂ₙ—CO— | nK |
| 4) Ring Structure —Aₙ— | Symbol |
| 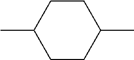 | H |
| 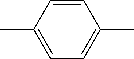 | B |
| 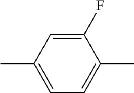 | B(F) |
| 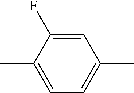 | B(2F) |
| 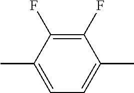 | B(2F,3F) |
| 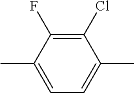 | B(2F,3Cl) |
| 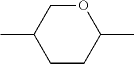 | dh |
| 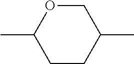 | Dh |
| 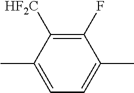 | B(2CF2H,3F) |
| 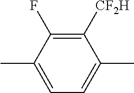 | B(2F,3CF2H) |
| 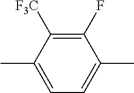 | B(2CF3,3F) |
| 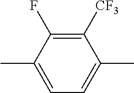 | B(2F,3CF3) |
| 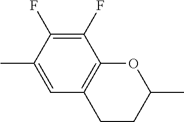 | Cro(7F,8F) |
| 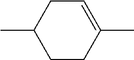 | ch |

5) Examples of Description
Example 1 2K—B(2CF2H,3F)BH-3

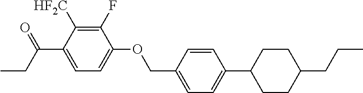

Example 2 5-H1KB(2CF2H,3F)—O2

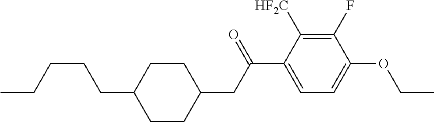

Example 3 3-HHB-1

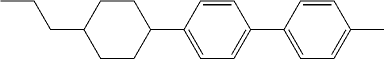 [SMILES: CCCC1CCC(c2ccc(-c3ccc(C)cc3)cc2)CC1]

Example 4 AC—BB—AC

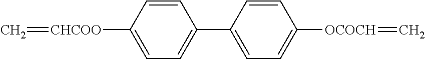

### Example 1

| | | |
|---|---|---|
| 5-H1KB (2CF2H, 3F)-O2 | (1-1) | 3% |
| 2K-B (2CF2H, 3F) BH-3 | (1-2) | 5% |
| 6K-B (2CF2H, 3F)-O2 | (1-2) | 5% |
| 3-HH-V | (2) | 12% |
| 3-HH-V1 | (2) | 7% |
| 1V2-BB-1 | (3-2) | 3% |
| 3-HHEH-3 | (3-3) | 3% |
| 3-HHB-O1 | (3-4) | 4% |
| 1-BB (F) B-2V | (3-6) | 5% |
| 5-HBB (F) B-2 | (3-12) | 3% |
| 5-HBB (F) B-3 | (3-12) | 4% |
| 3-HB (2F, 3F)-O2 | (4-1) | 12% |
| 3-BB (2F, 3F)-O2 | (4-4) | 7% |
| 2-HHB (2F, 3F)-O2 | (4-6) | 8% |
| 3-HH1OB (2F, 3F)-O2 | (4-8) | 7% |
| 2-BB (2F, 3F) B-3 | (4-9) | 5% |
| 2-BB (2F, 3F) B-4 | (4-9) | 7% |

NI=84.4° C.; Tc<−20° C.; η=24.5 mPa·s; Δn=0.131; Δε=−3.0; Vth=1.95 V; γ1=149.0 mPa·s.

### Comparative Example 1

A composition in Example 1 contains compound (1) as a first component. Compound (1) has a negative dielectric anisotropy. Compound (4) also has a negative dielectric anisotropy. For comparison, a composition in which three compounds being the first component in Example 1 were replaced to compound (4) similar to three compounds thereof, respectively, was taken as Comparative Example 1.

| | | |
|---|---|---|
| 5-H2B (2F, 3F)-O2 | (4-2) | 3% |
| 3-HBB (2F, 3F)-O2 | (4-10) | 5% |
| 5-HB (2F, 3F)-O2 | (4-1) | 5% |
| 3-HH-V | (2) | 12% |
| 3-HH-V1 | (2) | 7% |
| 1V2-BB-1 | (3-2) | 3% |
| 3-HHEH-3 | (3-3) | 3% |
| 3-HHB-O1 | (3-4) | 4% |
| 1-BB (F) B-2V | (3-6) | 5% |
| 5-HBB (F) B-2 | (3-12) | 3% |
| 5-HBB (F) B-3 | (3-12) | 4% |
| 3-HB (2F, 3F)-O2 | (4-1) | 12% |
| 3-BB (2F, 3F)-O2 | (4-4) | 7% |
| 2-HHB (2F, 3F)-O2 | (4-6) | 8% |
| 3-HH1OB (2F, 3F)-O2 | (4-8) | 7% |
| 2-BB (2F, 3F) B-3 | (4-9) | 5% |
| 2-BB (2F, 3F) B-4 | (4-9) | 7% |

NI=87.0° C.; Δn=0.132; Δε=−2.6.

### Example 2

| | | |
|---|---|---|
| 2-H1KB (2CF2H, 3F)-O2 | (1-1) | 3% |
| 3-H1KB (2CF2H, 3F)-O2 | (1-1) | 3% |
| 5-H1KB (2CF2H, 3F)-O2 | (1-1) | 3% |
| 5-HH1KB (2CF2H, 3F)-O2 | (1-1) | 3% |
| 3-HH-V | (2) | 19% |
| 3-HH-V1 | (2) | 7% |
| 3-HB-O2 | (3-1) | 4% |
| 3-HHB-O1 | (3-4) | 5% |
| 3-HB (F) HH-2 | (3-8) | 4% |
| 3-HB (2F, 3F)-O2 | (4-1) | 7% |
| 3-BB (2F, 3F)-O2 | (4-4) | 6% |
| 2-HHB (2F, 3F)-O2 | (4-6) | 6% |
| 3-HHB (2F, 3F)-O2 | (4-6) | 5% |
| V-HHB (2F, 3F)-O2 | (4-6) | 5% |
| 3-HH1OB (2F, 3F)-O2 | (4-8) | 8% |
| 2-BB (2F, 3F) B-3 | (4-9) | 3% |
| 2-BB (2F, 3F) B-4 | (4-9) | 5% |
| 3-HH1OCro (7F, 8F)-5 | (4-15) | 4% |

NI=74.5° C.; Tc<−20° C.; η=22.8 mPa·s; Δn=0.094; Δε=−4.5; Vth=1.80 V; γ1=140.9 mPa·s.

### Example 3

| | | |
|---|---|---|
| 5-HH1KB (2CF2H, 3F)-O2 | (1-1) | 3% |
| 2K-B (2CF2H, 3F) BH-3 | (1-2) | 5% |
| 6K-B (2CF2H, 3F)-O2 | (1-2) | 5% |
| 3-HH-V | (2) | 17% |
| 3-HH-V1 | (2) | 6% |
| F3-HH-V | (2) | 3% |
| F3-HH-V1 | (2) | 4% |
| 1-BB-3 | (3-2) | 6% |
| VFF2-HHB-1 | (3-4) | 5% |
| V-HHB-1 | (3-4) | 3% |
| V-HB (2F, 3F)-O2 | (4-1) | 4% |
| 3-H2B (2F, 3F)-O2 | (4-2) | 4% |
| 3-H1OB (2F, 3F)-O2 | (4-3) | 8% |
| V-HHB (2F, 3F)-O1 | (4-6) | 8% |
| V-HHB (2F, 3F)-O2 | (4-6) | 6% |
| 3-HH1OB (2F, 3F)-O2 | (4-8) | 3% |
| 2-BB (2F, 3F) B-4 | (4-9) | 7% |
| 1O1-HBBH-5 | (—) | 3% |

NI=72.7° C.; Tc<−20° C.; η=17.7 mPa·s; Δn=0.101; Δε=−3.2; Vth=1.94 V; γ1=132.1 mPa·s.

### Example 4

| | | |
|---|---|---|
| 3-HH1KB (2CF3, 3F)-O2 | (1-1) | 3% |
| 2K-B (2CF3, 3F) BH-3 | (1-2) | 3% |
| 2K-B (2CF3, 3F) BH-5 | (1-2) | 3% |
| 5-HH-VFF | (2) | 5% |
| 3-HH-V | (2) | 15% |
| 4-HH-V | (2) | 7% |
| 4-HH-V1 | (2) | 8% |
| 1-BB-5 | (3-2) | 5% |
| 2-BB (F) B-5 | (3-6) | 4% |
| 2-BB (F) B-2V | (3-6) | 6% |
| 3-HB (2F, 3F)-O2 | (4-1) | 10% |
| 3-BB (2F, 3F)-O2 | (4-4) | 4% |
| 5-HH2B (2F, 3F)-O2 | (4-7) | 6% |
| 2-HH1OB (2F, 3F)-O2 | (4-8) | 3% |
| 2-BB (2F, 3F) B-3 | (4-9) | 5% |
| 2-HBB (2F, 3F)-O2 | (4-10) | 5% |
| V-HBB (2F, 3F)-O2 | (4-10) | 8% |

NI=72.1° C.; Tc<−20° C.; η=9.4 mPa·s; Δn=0.118; Δε=−3.0; Vth=1.95 V; γ1=75.7 mPa·s.

### Example 5

| | | |
|---|---|---|
| 3-H1KB (2CF2H, 3F)-O2 | (1-1) | 3% |
| 5-H1KB (2CF2H, 3F)-O2 | (1-1) | 3% |
| 5-HH1KB (2CF2H, 3F)-O2 | (1-1) | 3% |
| 2K-B (2CF2H, 3F) BH-3 | (1-2) | 5% |
| 3-HH-V | (2) | 15% |
| 3-HH-V1 | (2) | 10% |
| 5-HH-V | (2) | 5% |
| 3-HHB-3 | (3-4) | 5% |
| V2-HHB-1 | (3-4) | 4% |
| 5-HB (F) BH-3 | (3-11) | 3% |
| 3-H1OB (2F, 3F)-O2 | (4-3) | 9% |
| V-H1OB (2F, 3F)-O2 | (4-3) | 7% |
| 5-B (2F, 3F) B (2F, 3F)-O2 | (4-5) | 3% |
| 3-HHB (2F, 3F)-O2 | (4-6) | 6% |
| V-HHB (2F, 3F)-O1 | (4-6) | 5% |
| V-HHB (2F, 3F)-O2 | (4-6) | 5% |
| 3-HH1OB (2F, 3F)-O2 | (4-8) | 6% |
| 3-HHB (2F, 3C1)-O2 | (4-12) | 3% |

NI=72.6° C.; Tc<−20° C.; η=23.0 mPa·s; Δn=0.083; Δε=−4.8; Vth=1.76 V; γ1=148.4 mPa·s.

### Example 6

| | | |
|---|---|---|
| 3-HH1KB (2CF3, 3F)-O2 | (1-1) | 3% |
| 2K-B (2CF3, 3F)BH-5 | (1-2) | 3% |
| 3-HH-V | (2) | 10% |
| 1V2-HH-1 | (2) | 3% |
| 1V2-HH-3 | (2) | 5% |
| 1V2-BB-1 | (3-2) | 5% |
| 3-HHB-O1 | (3-4) | 3% |
| V-HHB-1 | (3-4) | 3% |
| 3-BB (F) B-2V | (3-6) | 6% |
| 5-B (F) BB-3 | (3-7) | 3% |
| V-HB (2F, 3F)-O2 | (4-1) | 5% |
| 3-HB (2F, 3F)-O2 | (4-1) | 5% |
| 3-H2B (2F, 3F)-O2 | (4-2) | 7% |
| 2O-BB (2F, 3F)-O2 | (4-4) | 4% |
| 2-HHB (2F, 3F)-O2 | (4-6) | 5% |
| 3-HHB (2F, 3F)-O2 | (4-6) | 8% |
| V-HHB (2F, 3F)-O2 | (4-6) | 2% |
| 3-HH1OB (2F, 3F)-O2 | (4-8) | 5% |
| 2-BB (2F, 3F) B-3 | (4-9) | 6% |
| 2-BB (2F, 3F) B-4 | (4-9) | 6% |
| 3-HBB (2F, 3Cl)-O2 | (4-13) | 3% |

NI=84.1° C.; Tc<−20° C.; η=15.6 mPa·s; Δn=0.132; Δε=−3.1; Vth=1.94 V; γ1=124.7 mPa·s.

### Example 7

| | | |
|---|---|---|
| 2-H1KB (2CF2H, 3F)-O2 | (1-1) | 4% |
| 5-H1KB (2CF2H, 3F)-O2 | (1-1) | 4% |
| 5-HH1KB (2CF2H, 3F)-O2 | (1-1) | 3% |
| 6K-B (2CF2H, 3F)-O2 | (1-2) | 4% |
| 3-HH-V | (2) | 27% |
| 3-HH-V1 | (2) | 5% |
| 7-HB-1 | (3-1) | 4% |
| 3-HBB-2 | (3-5) | 3% |
| 3-HHEBH-3 | (3-9) | 3% |
| 3-HHEBH-4 | (3-9) | 3% |
| 3-HB (2F, 3F)-O2 | (4-1) | 4% |
| 5-H2B (2F, 3F)-O2 | (4-2) | 3% |
| 3-H1OB (2F, 3F)-O2 | (4-3) | 6% |
| V-HHB (2F, 3F)-O1 | (4-6) | 5% |
| V2-HHB (2F, 3F)-O2 | (4-6) | 3% |
| 3-HH2B (2F, 3F)-O2 | (4-7) | 3% |
| 5-HH2B (2F, 3F)-O2 | (4-7) | 5% |
| V-HH1OB (2F, 3F)-O2 | (4-8) | 3% |
| 2-HBB (2F, 3F)-O2 | (4-10) | 5% |
| 3-H1OCro (7F, 8F)-5 | (4-14) | 3% |

NI=71.0° C.; Tc<−20° C.; η=19.9 mPa·s; Δn=0.076; Δε=−4.3; Vth=1.82 V; γ1=138.9 mPa·s.

### Example 8

| | | |
|---|---|---|
| 5-H1KB (2CF2H, 3F)-O2 | (1-1) | 3% |
| 3-HH1KB (2CF2H, 3F)-O2 | (1-1) | 3% |
| 5-HH1KB (2CF2H, 3F)-O2 | (1-1) | 3% |
| 2K-B (2CF2H, 3F) BH-3 | (1-2) | 3% |
| 3-HH-VFF | (2) | 3% |
| 3-HH-V | (2) | 23% |
| 3-HH-V1 | (2) | 4% |
| 3-HHB-1 | (3-4) | 4% |
| V-HBB-2 | (3-5) | 3% |
| 5-B (F) BB-2 | (3-7) | 5% |
| 3-HHEBH-5 | (3-9) | 3% |
| 3-HB (2F, 3F)-O2 | (4-1) | 12% |
| V2-BB (2F, 3F)-O2 | (4-4) | 8% |
| 2-HHB (2F, 3F)-O2 | (4-6) | 5% |
| 3-HHB (2F, 3F)-O2 | (4-6) | 9% |
| V2-HHB (2F, 3F)-O2 | (4-6) | 4% |
| 2-BB (2F, 3F) B-4 | (4-9) | 5% |

NI=77.0° C.; Tc<−20° C.; η=16.9 mPa·s; Δn=0.103; Δε=−3.9; Vth=1.85 V; γ1=128.4 mPa·s.

### Example 9

| | | |
|---|---|---|
| 3-H1KB (2CF2H, 3F)-O2 | (1-1) | 5% |
| 5-HH1KB (2CF2H, 3F)-O2 | (1-1) | 3% |
| 2K-B (2CF2H, 3F) BH-3 | (1-2) | 5% |
| 3-HH-V | (2) | 13% |
| 2-HH-3 | (2) | 10% |
| 3-HH-4 | (2) | 4% |
| V2-BB-1 | (3-2) | 4% |
| V-HBB-3 | (3-5) | 3% |
| 2-BB (F) B-3 | (3-6) | 4% |
| 5-HBBH-3 | (3-10) | 3% |
| 3-HB (2F, 3F)-O2 | (4-1) | 4% |
| 3-BB (2F, 3F)-O2 | (4-4) | 6% |
| 2-HHB (2F, 3F)-O2 | (4-6) | 8% |
| 3-HH1OB (2F, 3F)-O2 | (4-8) | 8% |
| 2-BB (2F, 3F) B-3 | (4-9) | 3% |
| 2-BB (2F, 3F) B-4 | (4-9) | 3% |
| 3-HBB (2F, 3F)-O2 | (4-10) | 8% |
| 3-HEB (2F, 3F) B (2F, 3F)-O2 | (4-11) | 3% |
| 5-HBB (2F, 3Cl)-O2 | (4-13) | 3% |

NI=77.4° C.; Tc<−20° C.; η=24.9 mPa·s; Δn=0.113; Δε=−4.0;Vth=1.85 V; γ1=149.2 mPa·s.

### Example 10

| | | |
|---|---|---|
| 3-H1KB (2CF2H, 3F)-O2 | (1-1) | 8% |
| 3-HH-V | (2) | 22% |
| V-HHB-1 | (3-4) | 10% |
| V-HB (2F, 3F)-O2 | (4-1) | 3% |
| 3-HB (2F, 3F)-O2 | (4-1) | 3% |
| 3-BB (2F, 3F)-O2 | (4-4) | 7% |
| 2-HHB (2F, 3F)-O2 | (4-6) | 5% |
| 3-HHB (2F, 3F)-O2 | (4-6) | 8% |
| V-HHB (2F, 3F)-O1 | (4-6) | 5% |
| V-HHB (2F, 3F)-O2 | (4-6) | 10% |
| V-HHB (2F, 3F)-O4 | (4-6) | 4% |
| 3-HBB (2F, 3F)-O2 | (4-10) | 7% |
| V-HBB (2F, 3F)-O2 | (4-10) | 8% |

NI=85.7° C.; Tc<−20° C.; η=20.3 mPa·s; Δn=0.103; Δε=−4.8; Vth=1.78 V; γ1=139.6 mPa·s.

### Example 11

| | | |
|---|---|---|
| 3-H1KB (2CF2H, 3F)-O2 | (1-1) | 8% |
| 3-HH-V | (2) | 22% |
| V-HHB-1 | (3-4) | 10% |
| V-HB (2F, 3F)-O2 | (4-1) | 3% |
| 3-HB (2F, 3F)-O2 | (4-1) | 3% |
| 3-BB (2F, 3F)-O2 | (4-4) | 7% |
| 2-HHB (2F, 3F)-O2 | (4-6) | 5% |
| 3-HHB (2F, 3F)-O2 | (4-6) | 8% |
| V-HHB (2F, 3F)-O1 | (4-6) | 5% |
| V-HHB (2F, 3F)-O2 | (4-6) | 10% |
| V-HHB (2F, 3F)-O4 | (4-6) | 4% |
| 3-HBB (2F, 3F)-O2 | (4-10) | 5% |
| V-HBB (2F, 3F)-O2 | (4-10) | 5% |
| 3-HDhB (2F, 3F)-O2 | (4-16) | 5% |

NI=84.5° C.; Tc<−20° C.; η=20.8 mPa·s; Δn=0.099; Δε=−4.9; Vth=1.78 V; γ1=140.2 mPa·s.

### Example 12

| | | |
|---|---|---|
| 3-H1KB (2CF2H, 3F)-O2 | (1-1) | 8% |
| 3-HH-V | (2) | 22% |
| V-HHB-1 | (3-4) | 10% |
| V-HB (2F, 3F)-O2 | (4-1) | 3% |
| 3-HB (2F, 3F)-O2 | (4-1) | 3% |
| 3-BB (2F, 3F)-O2 | (4-4) | 7% |
| 2-HHB (2F, 3F)-O2 | (4-6) | 5% |
| 3-HHB (2F, 3F)-O2 | (4-6) | 8% |
| V-HHB (2F, 3F)-O1 | (4-6) | 5% |
| V-HHB (2F, 3F)-O2 | (4-6) | 10% |
| V-HHB (2F, 3F)-O4 | (4-6) | 4% |
| 3-HBB (2F, 3F)-O2 | (4-10) | 5% |
| V-HBB (2F, 3F)-O2 | (4-10) | 5% |
| 3-dhBB (2F, 3F)-O2 | (4-17) | 5% |

NI=85.6° C.; Tc<−20° C.; η=20.9 mPa·s; Δn=0.103; Δε=−4.8; Vth=1.79 V; γ1=141.5 mPa·s.

### Example 13

| | | |
|---|---|---|
| 3-H1KB (2CF2H, 3F)-O2 | (1-1) | 8% |
| 3-HH-V | (2) | 22% |
| V-HHB-1 | (3-4) | 10% |
| V-HB (2F, 3F)-O2 | (4-1) | 3% |
| 3-HB (2F, 3F)-O2 | (4-1) | 3% |
| 3-BB (2F, 3F)-O2 | (4-4) | 7% |
| 2-HHB (2F, 3F)-O2 | (4-6) | 5% |
| 3-HHB (2F, 3F)-O2 | (4-6) | 8% |
| V-HHB (2F, 3F)-O1 | (4-6) | 5% |
| V-HHB (2F, 3F)-O2 | (4-6) | 10% |
| V-HHB (2F, 3F)-O4 | (4-6) | 4% |
| 3-HBB (2F, 3F)-O2 | (4-10) | 5% |
| V-HBB (2F, 3F)-O2 | (4-10) | 5% |
| V-chB (2F, 3F)-O2 | (4-18) | 5% |

NI=77.2° C.; Tc<−20° C.; η=19.0 mPa·s; Δn=0.098; Δε=−4.8; Vth=1.82 V; γ1=137.6 mPa·s.

### Example 14

| | | |
|---|---|---|
| 3-H1KB (2CF2H, 3F)-O2 | (1-1) | 8% |
| 3-HH-V | (2) | 22% |
| V-HHB-1 | (3-4) | 10% |
| V-HB (2F, 3F)-O2 | (4-1) | 3% |
| 3-HB (2F, 3F)-O2 | (4-1) | 3% |
| 3-BB (2F, 3F)-O2 | (4-4) | 7% |
| 2-HHB (2F, 3F)-O2 | (4-6) | 5% |
| 3-HHB (2F, 3F)-O2 | (4-6) | 8% |
| V-HHB (2F, 3F)-O1 | (4-6) | 5% |
| V-HHB (2F, 3F)-O2 | (4-6) | 10% |
| V-HHB (2F, 3F)-O4 | (4-6) | 4% |
| 3-HBB (2F, 3F)-O2 | (4-10) | 5% |
| V-HBB (2F, 3F)-O2 | (4-10) | 5% |
| 3-HchB (2F, 3F)-O2 | (4-19) | 5% |

NI=86.5° C.; Tc<−20° C.; η=19.7 mPa·s; Δn=0.101; Δε=−4.8; Vth=1.80 V; γ1=135.3 mPa·s.

The dielectric anisotropy (Δε) of the composition in Comparative Example 1 was −2.6. On the other hand, the dielectric anisotropy of the composition in Example 1 was −2.9. Thus, the composition in Example had a large negative dielectric anisotropy in comparison with the composition in Comparative Example. Accordingly, the liquid crystal composition of the invention is concluded to have excellent characteristics.

Although the invention has been described and illustrated with a certain degree of particularity, it is understood that the disclosure has been made only by way of example, and that numerous changes in the conditions and order of steps can be resorted to by those skilled in the art without departing from the spirit and scope of the invention.

### INDUSTRIAL APPLICABILITY

A liquid crystal composition of the invention satisfies at least one of characteristics such as a high maximum temperature of a nematic phase, a low minimum temperature of the nematic phase, a small viscosity, a suitable optical anisotropy, a large negative dielectric anisotropy, a large specific resistance, a high stability to ultraviolet light, a high stability to heat or the like, or has a suitable balance regarding at least two of the characteristics. A liquid crystal display device including the composition has characteristics such as a short response time, a large voltage holding ratio, a low threshold voltage, a large contrast ratio, a long service life and so forth, and thus can be used for a liquid crystal projector, a liquid crystal television and so forth.

What is claimed is:

1. A liquid crystal composition that has a negative dielectric anisotropy and contains at least one compound selected from the group consisting of compounds represented by formula (1) as a first component, and at least one compound selected from the group consisting of compounds represented by formula (2) as a second component: 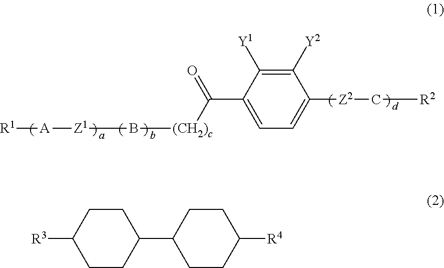
wherein, in formula (1) to formula (2), R¹ and R² are independently hydrogen, fluorine, chlorine, alkyl having 1 to 12 carbons, alkenyl having 2 to 12 carbons, alkenyloxy having 2 to 12 carbons, alkyl having 1 to 12 carbons in which at least one of hydrogen is replaced by fluorine or chlorine, or alkenyl having 2 to 12 carbons in which at least one of hydrogen is replaced by fluorine or chlorine; R³ and R⁴ are independently alkyl having 1 to 12 carbons, alkenyl having 2 to 12 carbons, alkyl having 1 to 12 carbons in which at least one of hydrogen is replaced by fluorine or chlorine, or alkenyl having 2 to 12 carbons in which at least one of hydrogen is replaced by fluorine or chlorine; A, B and C are independently 1,4-cyclohexylene, 1,4-cyclohexenylene, 1,4-phenylene, or 1,4-phenylene in which at least one of hydrogen is replaced with fluorine or chlorine, or tetrahydropyran-2,5-diyl, naphthalene-2,6-diyl, naphthalene-2,6-diyl in which at least one of hydrogen is replaced by fluorine or chlorine, chroman-2,6-diyl, or chroman-2,6-diyl in which at least one of hydrogen is replaced by fluorine or chlorine; Z¹ and Z² are independently a single bond, ethylene, carbonyloxy or methyleneoxy; Y¹ is CF₂H or —CF₃; Y² is hydrogen, fluorine, chlorine, —CFH₂, —CF₂H or —CF₃; a, b and d are independently 0, 1, 2 or 3, and a sum of a, b and d is 3 or less; and c is 0, 1, 2, 3, 4, 5, 6, 7, 8, 9 or 10.

2. The liquid crystal composition according to claim 1, containing at least one compound selected from the group consisting of compounds represented by formula (1-1) or formula (1-2) as the first component: 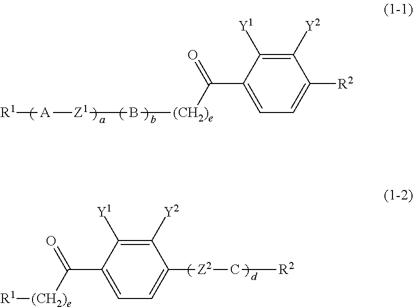
wherein, in formula (1-1) or formula (1-2), R¹ and R² are independently hydrogen, fluorine, chlorine, alkyl having 1 to 12 carbons, alkenyl having 2 to 12 carbons, alkenyloxy having 2 to 12 carbons, alkyl having 1 to 12 carbons in which at least one of hydrogen is replaced by fluorine or chlorine, or alkenyl having 2 to 12 carbons in which at least one of hydrogen is replaced by fluorine or chlorine; A, B and C are independently 1,4-cyclohexylene, 1,4-cyclohexenylene, 1,4-phenylene, or 1,4-phenylene in which at least one of hydrogen is replaced by fluorine or chlorine, or tetrahydropyran-2,5-diyl, naphthalene-2,6-diyl, naphthalene-2,6-diyl in which at least one of hydrogen is replaced by fluorine or chlorine, chroman-2,6-diyl, or chroman-2,6-diyl in which at least one of hydrogen is replaced by fluorine or chlorine; Z¹ and Z² are independently a single bond, ethylene, carbonyloxy or methyleneoxy; Y¹ is CF₂H or —CF₃; Y² is hydrogen, fluorine, chlorine, —CFH₂, —CF₂H or —CF₃; a, b and d are independently 0, 1, 2 or 3, and a sum of a and b is 1, 2 or 3; and e is 0, 1, 2, 3, 4 or 5.

3. The liquid crystal composition according to claim 1, wherein a ratio of the first component is in the range of 3% by weight to 30% by weight and a ratio of the second component is in the range of 5% by weight to 60% by weight, based on the weight of the liquid crystal composition.

4. The liquid crystal composition according to claim 1, containing at least one compound selected from the group consisting of compounds represented by formula (3) as a third component: 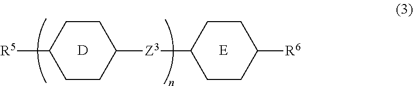
wherein, in formula (3), R⁵ and R⁶ are independently alkyl having 1 to 12 carbons, alkoxy having 1 to 12 carbons, alkenyl having 2 to 12 carbons, alkyl having 1 to 12 carbons in which at least one of hydrogen is replaced by fluorine or chlorine, or alkenyl having 2 to 12 carbons in which at least one of hydrogen is replaced by fluorine or chlorine; ring D and ring E are independently 1,4-cyclohexylene, 1,4-phenylene, 2-fluoro-1,4-phenylene or 2,5-difluoro-1,4-phenylene; Z³ is a single bond, ethylene or carbonyloxy; n is 1, 2, or 3; and ring E when n is 1 is 1,4-phenylene.

5. The liquid crystal composition according to claim 4, containing at least one compound selected from the group consisting of compounds represented by formula (3-1) to formula (3-12) as the third component: 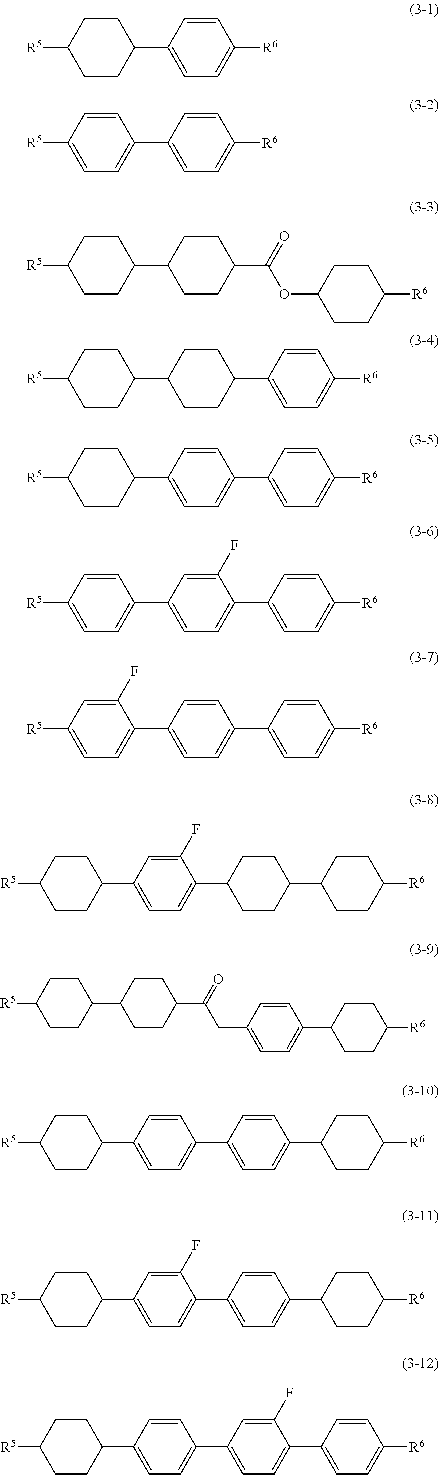
wherein, in formula (3-1) to formula (3-12), R⁵ and R⁶ are independently alkyl having 1 to 12 carbons, alkoxy having 1 to 12 carbons, alkenyl having 2 to 12 carbons, alkyl having 1 to 12 carbons in which at least one of hydrogen is replaced by fluorine or chlorine, or alkenyl having 2 to 12 carbons in which at least one of hydrogen is replaced by fluorine or chlorine.

6. The liquid crystal composition according to claim 4, wherein a ratio of the third component is in the range of 5% by weight to 50% by weight based on the weight of the liquid crystal composition.

7. The liquid crystal composition according to claim 1, containing at least one compound selected from the group consisting of compounds represented by formula (4) as a fourth component: 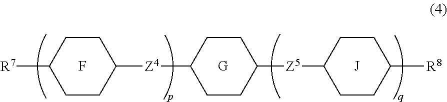
wherein, in formula (4), R⁷ and R⁸ are independently alkyl having 1 to 12 carbons, alkoxy having 1 to 12 carbons, alkenyl having 2 to 12 carbons, alkenyloxy having 2 to 12 carbons, or alkyl having 1 to 12 carbons in which at least one of hydrogen is replaced by fluorine or chlorine; ring F and ring J are independently 1,4-cyclohexylene, 1,4-cyclohexenylene, tetrahydropyran-2,5-diyl, 1,4-phenylene, or 1,4-phenylene in which at least one of hydrogen is replaced by fluorine or chlorine; ring G is 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl, or 7,8-difluorochroman-2,6-diyl; Z⁴ and Z⁵ are independently a single bond, ethylene, carbonyloxy or methyleneoxy; p is 1, 2 or 3; q is 0 or 1; and a sum of p and q is 3 or less.

8. The liquid crystal composition according to claim 7, containing at least one compound selected from the group consisting of compounds represented by formula (4-1) to formula (4-19) as the fourth component: 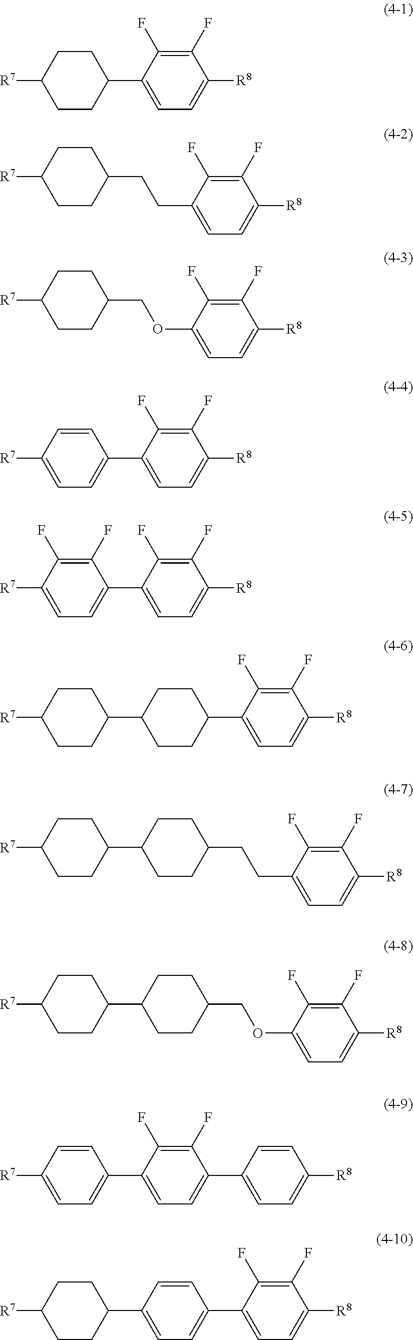 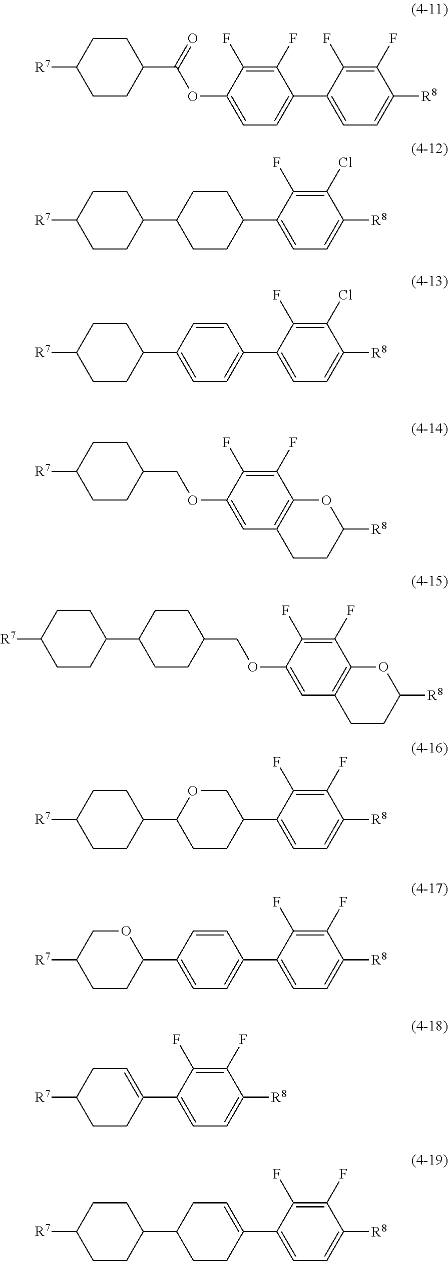
wherein, in formula (4-1) to formula (4-19), R⁷ and R⁸ are independently alkyl having 1 to 12 carbons, alkoxy having 1 to 12 carbons, alkenyl having 2 to 12 carbons, alkenyloxy having 2 to 12 carbons, or alkyl having 1 to 12 carbons in which at least one of hydrogen is replaced by fluorine or chlorine.

9. The liquid crystal composition according to claim 7, wherein a ratio of the fourth component is in the range of 15% by weight to 80% by weight based on the weight of the liquid crystal composition.

10. The liquid crystal composition according to claim 4, containing at least one compound selected from the group consisting of compounds represented by formula (4) as a fourth component: 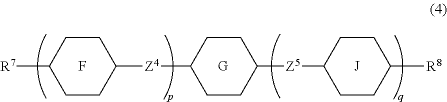
wherein, in formula (4), R⁷ and R⁸ are independently alkyl having 1 to 12 carbons, alkoxy having 1 to 12 carbons, alkenyl having 2 to 12 carbons, alkenyloxy having 2 to 12 carbons, or alkyl having 1 to 12 carbons in which at least one of hydrogen is replaced by fluorine or chlorine; ring F and ring J are independently 1,4-cyclohexylene, 1,4-cyclohexenylene, tetrahydropyran-2,5-diyl, 1,4-phenylene, or 1,4-phenylene in which at least one of hydrogen is replaced by fluorine or chlorine; ring G is 2,3-difluoro-1,4-phenylene, 2-chloro-3-fluoro-1,4-phenylene, 2,3-difluoro-5-methyl-1,4-phenylene, 3,4, 5-trifluoronaphthalene-2,6-diyl, or 7,8-difluorochroman-2,6-diyl; Z⁴ and Z⁵ are independently a single bond, ethylene, carbonyloxy or methyleneoxy; p is 1, 2 or 3; q is 0 or 1; and a sum of p and q is 3 or less.

11. The liquid crystal composition according to claim 1, containing at least one polymerizable compound selected from the group consisting of compounds represented by formula (5) as an additive component: 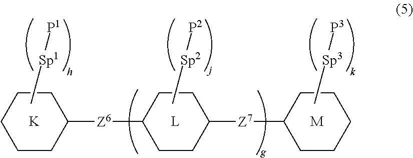
wherein, in formula (5), ring K and ring M are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one of hydrogen may be replaced by fluorine, chlorine, alkyl having 1 to 12 carbons, alkoxy having 1 to 12 carbons, or alkyl having 1 to 12 carbons in which at least one of hydrogen is replaced by fluorine or chlorine; ring L is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in the rings, at least one of hydrogen may be replaced by fluorine, chlorine, alkyl having 1 to 12 carbons, alkoxy having 1 to 12 carbons, or alkyl having 1 to 12 carbons in which at least one of hydrogen is replaced by fluorine or chlorine; Z⁶ and Z⁷ are independently a single bond or alkylene having 1 to 10 carbons, and in the alkylene, at least one of —CH₂— may be replaced by —O—, —CO—, —COO— or —OCO—, at least one of —CH₂—CH₂— may be replaced by —CH═CH—, —C(CH₃)═CH—, —CH═C(CH₃)— or —C(CH₃)═C(CH₃)—, and in the groups, at least one of hydrogen may be replaced by fluorine or chlorine; P¹, P² and P³ are a polymerizable group; Sp¹, Sp² and Sp³ are independently a single bond or alkylene having 1 to 10 carbons, and in the alkylene, at least one of —CH₂— may be replaced by —O—, —COO—, —OCO— or —OCOO—, at least one of —CH₂—CH₂— may be replaced by —CH═CH— or —C≡C—, and in the groups, at least one of hydrogen may be replaced by fluorine or chlorine; g is 0, 1 or 2; h, j and k are independently 0, 1, 2, 3 or 4; and a sum of h, j and k is 1 or more.

12. The liquid crystal composition according to claim 11, wherein, in formula (6), P¹, P² and P³ are independently a polymerizable group selected from the group consisting of groups represented by formula (P-1) to formula (P-6): 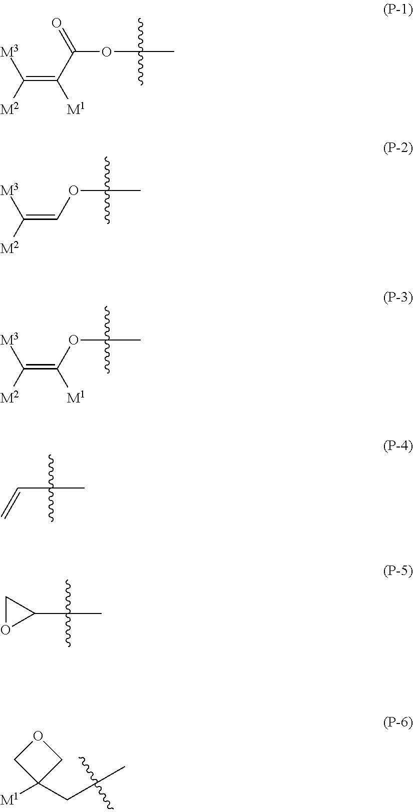
wherein, in formula (P-1) to formula (P-6), M¹, M² and M³ are independently hydrogen, fluorine, alkyl having 1 to 5 carbons, or alkyl having 1 to 5 carbons in which at least one of hydrogen is replaced by fluorine or chlorine; and
in formula (5), when all of h pieces of P¹ and k pieces of P³ are a group represented by formula (P-4), at least one of h pieces of Sp¹ and k pieces of Sp³ is alkylene in which at least one of —CH₂— is replaced by —O—, —OCO—, —OCO— or —OCOO—.

13. The liquid crystal composition according to claim 11, containing least one polymerizable compound selected from the group consisting of compounds represented by formula (5-1) to formula (5-27) as the additive component: 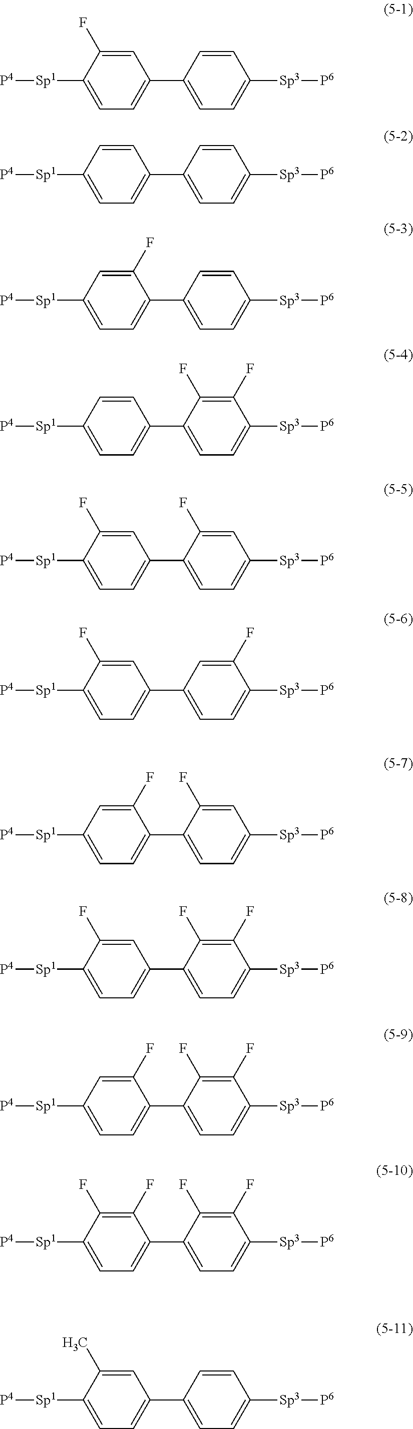 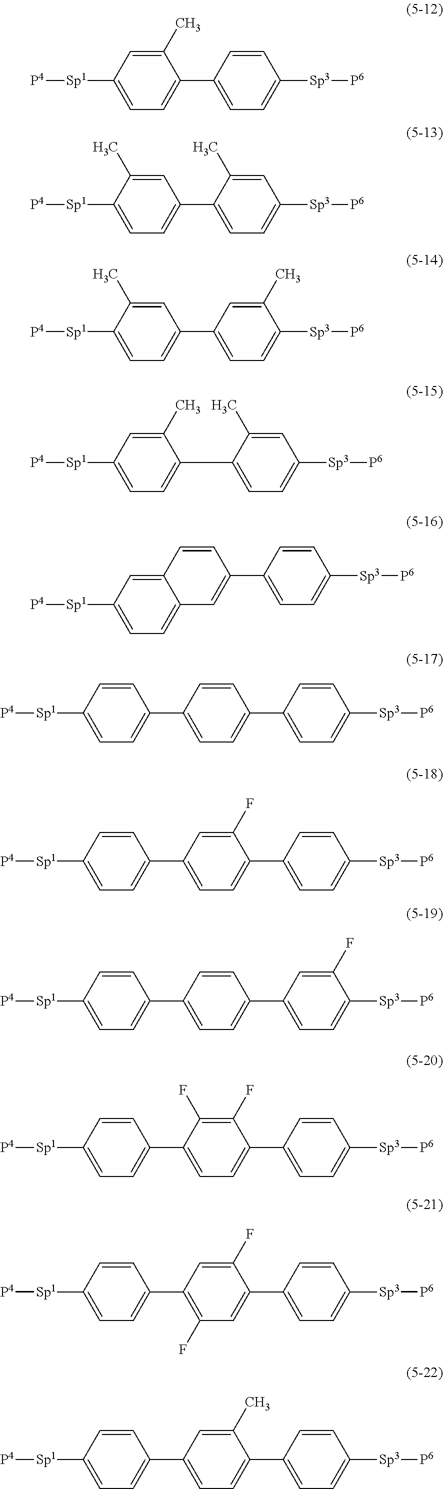 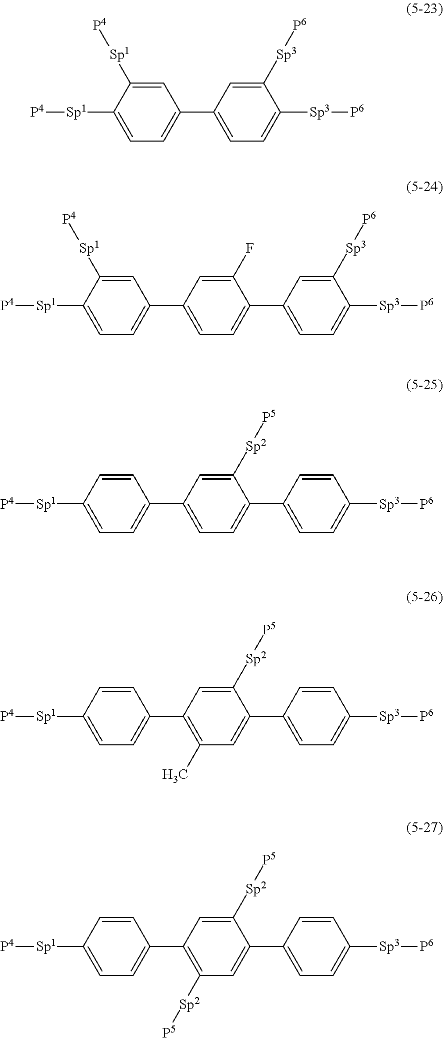
wherein, in formula (5-1) to formula (5-27), P⁴, P⁵ and P⁶ are independently a polymerizable group selected from the group consisting of groups represented by formula (P-1) to formula (P-3): 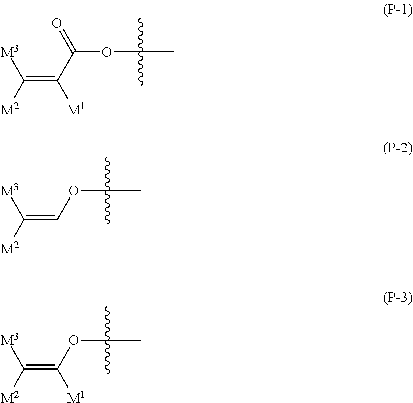
wherein, in formula (P-1) to formula (P-3), M¹, M² and M³ are independently hydrogen, fluorine, alkyl having 1 to 5 carbons, or alkyl having 1 to 5 carbons in which at least one of hydrogen is replaced by fluorine or chlorine; and
in formula (5-1) to formula (5-27), Sp¹, Sp² and Sp³ are independently a single bond or alkylene having 1 to 10 carbons, and in the alkylene, at least one of —CH₂— may be replaced by —O—, —OCO—, —OCO— or —OCOO—, at least one of —CH₂—CH₂— may be replaced by —CH═CH— or —C≡C—, and in the groups, at least one of hydrogen may be replaced by fluorine or chlorine.

14. The liquid crystal composition according to claim 11, wherein a ratio of the additive component is in the range of 0.03% by weight to 10% by weight based on the weight of the liquid crystal composition.

15. The liquid crystal composition according to claim 4, containing at least one polymerizable compound selected from the group consisting of compounds represented by formula (5) as an additive component: 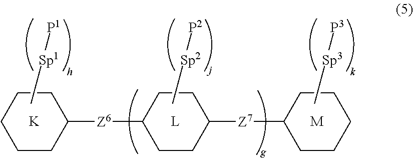
wherein, in formula (5), ring K and ring M are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one of hydrogen may be replaced by fluorine, chlorine, alkyl having 1 to 12 carbons, alkoxy having 1 to 12 carbons, or alkyl having 1 to 12 carbons in which at least one of hydrogen is replaced by fluorine or chlorine; ring L is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in the rings, at least one of hydrogen may be replaced by fluorine, chlorine, alkyl having 1 to 12 carbons, alkoxy having 1 to 12 carbons, or alkyl having 1 to 12 carbons in which at least one of hydrogen is replaced by fluorine or chlorine; Z⁶ and Z⁷ are independently a single bond or alkylene having 1 to 10 carbons, and in the alkylene, at least one of —CH₂— may be replaced by —O—, —CO—, —COO— or —OCO—, at least one of —CH₂—CH₂— may be replaced by —CH═CH—, —C(CH₃)═CH—, —CH═C(CH₃)— or —C(CH₃)═C(CH₃)—, and in the groups, at least one of hydrogen may be replaced by fluorine or chlorine; P¹, P² and P³ are a polymerizable group; Sp¹, Sp² and Sp³ are independently a single bond or alkylene having 1 to 10 carbons, and in the alkylene, at least one of —CH₂— may be replaced by —O—, —COO—, —OCO— or —OCOO—, at least one of —CH₂—CH₂— may be replaced by —CH═CH— or —C≡C—, and in the groups, at least one of hydrogen may be replaced by fluorine or chlorine; g is 0, 1 or 2; h, j and k are independently 0, 1, 2, 3 or 4; and a sum of h, j and k is 1 or more.

16. The liquid crystal composition according to claim 7, containing at least one polymerizable compound selected from the group consisting of compounds represented by formula (5) as an additive component: 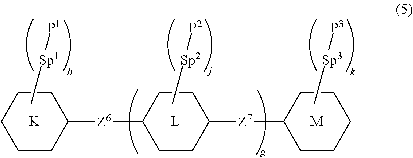
wherein, in formula (5), ring K and ring M are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one of hydrogen may be replaced by fluorine, chlorine, alkyl having 1 to 12 carbons, alkoxy having 1 to 12 carbons, or alkyl having 1 to 12 carbons in which at least one of hydrogen is replaced by fluorine or chlorine; ring L is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2, 5-diyl or pyridine-2, 5-diyl, and in the rings, at least one of hydrogen may be replaced by fluorine, chlorine, alkyl having 1 to 12 carbons, alkoxy having 1 to 12 carbons, or alkyl having 1 to 12 carbons in which at least one of hydrogen is replaced by fluorine or chlorine; Z⁶ and Z⁷ are independently a single bond or alkylene having 1 to 10 carbons, and in the alkylene, at least one of —CH₂— may be replaced by —O—, —CO—, —COO— or —OCO—, at least one of —CH₂—CH₂— may be replaced by —CH═CH—, —C(CH₃)═CH—, —CH═C(CH₃)— or —C(CH₃)═C(CH₃)—, and in the groups, at least one of hydrogen may be replaced by fluorine or chlorine; P¹, P² and P³ are a polymerizable group; Sp¹, Sp² and Sp³ are independently a single bond or alkylene having 1 to 10 carbons, and in the alkylene, at least one of —CH₂— may be replaced by —O—, —COO—, —OCO— or —OCOO—, at least one of —CH₂—CH₂— may be replaced by —CH═CH— or —C≡C—, and in the groups, at least one of hydrogen may be replaced by fluorine or chlorine; g is 0, 1 or 2; h, j and k are independently 0, 1, 2, 3 or 4; and a sum of h, j and k is 1 or more.

17. The liquid crystal composition according to claim 10, containing at least one polymerizable compound selected from the group consisting of compounds represented by formula (5) as an additive component: 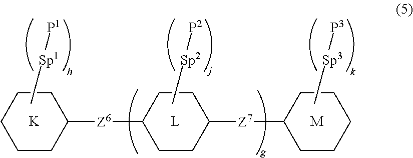
wherein, in formula (5), ring K and ring M are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one of hydrogen may be replaced by fluorine, chlorine, alkyl having 1 to 12 carbons, alkoxy having 1 to 12 carbons, or alkyl having 1 to 12 carbons in which at least one of hydrogen is replaced by fluorine or chlorine; ring L is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in the rings, at least one of hydrogen may be replaced by fluorine, chlorine, alkyl having 1 to 12 carbons, alkoxy having 1 to 12 carbons, or alkyl having 1 to 12 carbons in which at least one of hydrogen is replaced by fluorine or chlorine; Z⁶ and Z⁷ are independently a single bond or alkylene having 1 to 10 carbons, and in the alkylene, at least one of —CH₂— may be replaced by —O—, —CO—, —COO— or —OCO—, at least one of —CH₂—CH₂— may be replaced by —CH═CH—, —C(CH₃)═CH—, —CH═C(CH₃)— or —C(CH₃)═C(CH₃)—, and in the groups, at least one of hydrogen may be replaced by fluorine or chlorine; P¹, P² and P³ are a polymerizable group; Sp¹, Sp² and Sp³ are independently a single bond or alkylene having 1 to 10 carbons, and in the alkylene, at least one of —CH₂— may be replaced by —O—, —COO—, —OCO— or —OCOO—, at least one of —CH₂—CH₂— may be replaced by —CH═CH— or —C≡C—, and in the groups, at least one of hydrogen may be replaced by fluorine or chlorine; g is 0, 1 or 2; h, j and k are independently 0, 1, 2, 3 or 4; and a sum of h, j and k is 1 or more.

18. A liquid crystal display device, including the liquid crystal composition according to claim 1.

19. The liquid crystal display device according to claim 18, wherein an operating mode in the liquid crystal display device includes an IPS mode, a VA mode, an FFS mode or an FPA mode, and a driving mode in the liquid crystal display device includes an active matrix mode.

20. A polymer sustained alignment mode liquid crystal display device, wherein the liquid crystal display device includes the liquid crystal composition according to claim 11, or a polymerizable compound in the liquid crystal composition is polymerized.
